(19) United States
(12) Patent Application Publication
(10) Pub. No.: US 2014/0118378 A1
(43) Pub. Date: May 1, 2014

(54) METHOD FOR DRIVING DISPLAY DEVICE

(71) Applicant: Semiconductor Energy Laboratory Co., Ltd., Atsugi-shi (JP)

(72) Inventors: Jun Koyama, Kanagawa (JP); Yuji Iwaki, Kanagawa (JP); Hiroyuki Miyake, Kanagawa (JP); Toru Tanabe, Tokyo (JP)

(73) Assignee: Semiconductor Energy Laboratory Co., Ltd., Atsugi-shi (JP)

(21) Appl. No.: 14/064,306

(22) Filed: Oct. 28, 2013

(30) Foreign Application Priority Data
Oct. 30, 2012 (JP) 2012-239682

(51) Int. Cl. G09G 5/393

(52) U.S. Cl. CPC G09G 5/393
USPC 345/546

(57) ABSTRACT

A novel method for driving a display device in which generation of flickers caused by rewriting pixels is reduced and which has a high aperture ratio is provided. The driving method includes a first step of determining whether displayed still image data is two-valued still image data or multivalued still image data, and a second step of performing display by rewriting (refreshing) the two-valued still image data with lower frequency than the multivalued still image data.

### BACKGROUND OF THE INVENTION

1. Field of the Invention

The present invention relates to a method for driving a display device. In particular, the present invention relates to a method for driving a liquid crystal display device.

2. Description of the Related Art

A technique is known in which a refresh rate is reduced when a still image is displayed on a liquid crystal display device, so that power consumption is reduced.

To suppress image degradation which occurs when a still image is displayed while the refresh rate is reduced, a liquid crystal display device is known in which the smaller the gray scale level is, the lower the refresh rate at the time of displaying, on a display portion, an image corresponding to an image signal is.

### REFERENCE

### Patent Document

[Patent Document 1] Japanese Published Patent Application No. 2011-186449
[Patent Document 2] Japanese Published Patent Application No. 2011-191746

### SUMMARY OF THE INVENTION

A display device forms an image using pixels, and rewriting (refresh) of the pixels is performed normally with a frequency of 60 Hz (at regular intervals of about 1/60 second). Users get eyestrain by using or observing images which are rewritten with such a frequency (refresh rate) for hours.

In order to reduce eyestrain, it is effective to reduce the frequency of rewriting images. However, when the rewriting frequency is reduced, time for holding an image becomes longer; thus, the held image might be degraded.

To prevent this, a configuration in which a relatively large capacitor is provided in a pixel has been employed.

However, when the size of the capacitor is increased, the aperture ratio of the pixel is decreased, which makes it difficult to utilize a backlight effectively. Accordingly, the power consumption might be increased. Further, when the frequency of rewriting images cannot be reduced, eyestrain cannot be reduced in some cases.

One embodiment of the present invention is made in view of the foregoing technical background. An object of one embodiment of the present invention is to provide a novel method for driving a display device.

One embodiment of the present invention is a method for driving a display device which includes two steps: a first step of determining whether displayed still image data is two-valued still image data or multivalued still image data and a second step of performing display by rewriting the two-valued still image data with lower frequency than the multivalued still image data.

Further, one embodiment of the present invention is a method for driving a display device in which in the first step, the determination is made based on information that the still image data includes the multivalued data or not.

Further, one embodiment of the present invention is a method for driving a display device in which in the first step, the determination is made based on metafile having information that the still image data includes the multivalued data or not.

One embodiment of the present invention is a method for driving a display device which includes four steps: a first step of determining whether displayed first still image data is two-valued still image data or multivalued still image data, a second step of performing display by rewriting the two-valued first still image data with lower frequency than the multivalued still image data, a third step of terminating display of the first still image data, and a fourth step of performing display by rewriting moving image data with greater frequency than the two-valued still image data.

One embodiment of the present invention is a method for driving the display device in which the moving image is generated by obtaining weighted average of the first still image data and second still image data which is displayed sequentially after the first still image data using successively varying coefficients.

According to one embodiment of the present invention, a novel method for driving a display device can be provided.

### BRIEF DESCRIPTION OF THE DRAWINGS

FIG. 1 is a diagram showing characteristics of the transmittance of a liquid crystal element with respect to input voltage.

FIG. 2 is a block diagram illustrating a structure of a display device of one embodiment.

FIG. 3 is a flow chart illustrating a method for driving a display device of one embodiment.

FIG. 4 is a block diagram illustrating a structure of a display device of one embodiment.

FIGS. 5A and 5B illustrate a structure of a display panel of a display device of one embodiment.

FIG. 6 illustrates a structure of a display panel of a display device of one embodiment.

FIGS. 7A and 7B are diagrams illustrating a display method of a display device of one embodiment.

FIGS. 8A and 8B are a top view and a cross-sectional view illustrating a structure of a display panel of one embodiment.

FIGS. 9A to 9C each illustrate an electronic device of one embodiment.

FIGS. 10A to 10C illustrate a structure of a transistor which is applicable to a display panel of one embodiment.

FIGS. 11A to 11D are cross-sectional views illustrating a method for manufacturing a transistor which is applicable to a display device of one embodiment.

FIGS. 12A and 12B are cross-sectional views illustrating a method for manufacturing a first electrode of a display panel of one embodiment.

### DETAILED DESCRIPTION OF THE INVENTION

### Embodiment 1

A display device includes a display portion in which a plurality of pixels is provided in a matrix. In each pixel, a sub-pixel is provided. In the sub-pixel, a liquid crystal element and a color filter are provided, for example.

### <Characteristics of Liquid Crystal Element>

A liquid crystal element is one embodiment of an electro-optical element, includes a pair of polarizing plates, a pair of electrodes between the pair of polarizing plates and a liquid crystal layer between the pair of electrodes, and has transmittance which varies in accordance with a signal input to the pair of electrodes. A liquid crystal display device includes a backlight on the back side of a sub-pixel provided with a liquid crystal element. The liquid crystal element included in the liquid crystal display device controls light emitted from the backlight, and adjusts the intensity of light transmitted to a user's side. Accordingly, color displayed in each pixel can be controlled.

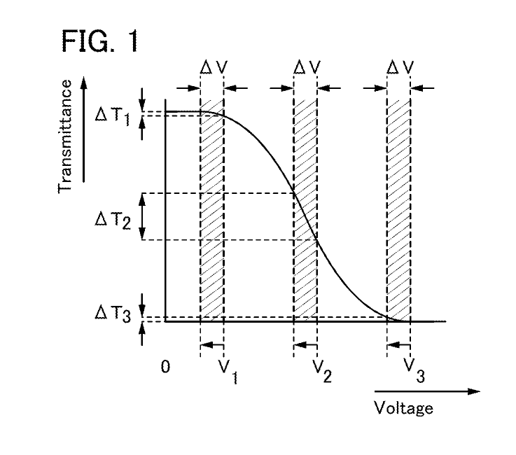

The transmittance characteristics of the liquid crystal element which vary in accordance with an input signal are described. FIG. 1 shows the characteristics of a normally white liquid crystal element. In FIG. 1, the vertical axis represents the transmittance of the liquid crystal element and the horizontal axis represents voltage applied to a pair of electrodes of the liquid crystal element.

The normally white liquid crystal element has high transmittance when the voltage applied to the pair of electrodes is low and low transmittance when the voltage applied to the pair of electrodes is high.

The transmittance of the liquid crystal element is not changed evenly with respect to change of the applied voltage. In the case shown in FIG. 1, the change of the transmittance in accordance with the change of the applied voltage is small in a region where the applied voltage is in the range of 0 V to V₁ and greater than V₃. In contrast, the transmittance is changed sensitively in response to the change of the voltage in a region where the applied voltage is around V₂.

In the case where a liquid crystal element having such characteristics is provided in each sub-pixel, the following problems occur.

The sub-pixel holds voltage applied between a pair of electrodes of the liquid crystal element, so that an image displayed in the sub-pixel is held. Here, in the case where there is a path through which current leaks in the sub-pixel, part of charge is leaked as a certain period (e.g., rewriting period of images) passes, so that the voltage applied between the pair of electrodes is lowered by ΔV.

Specifically, the sub-pixel in which writing is performed to hold the voltage V₁ is lowered to (V₁−ΔV), the sub-pixel in which writing is performed to hold the voltage V₂ is lowered to (V₂−ΔV), and the sub-pixel in which writing is performed to hold the voltage V₃ is lowered to (V₃−ΔV).

Further, in focusing on the change of the transmittance, the voltage of the sub-pixel in which writing is performed to hold the voltage V₂ is changed from V₂ to (V₂−ΔV), so that the transmittance is changed by ΔT₂. When ΔT₂ is large, the transmittance of the sub-pixel deviates noticeably from a desired value (in the normally white liquid crystal element, the transmittance is increased).

However, even with the same level of the voltage decreased for a certain period, the change of the transmittance ΔT₁ in accordance with the change from V₁ to (V₁−ΔV) or the change of the transmittance ΔT₃ in accordance with the change from V₃ to (V₃−ΔV) is markedly smaller than the change of the transmittance ΔT₂ in accordance with the change from V₂ to (V₂−ΔV).

The above shows that degradation easily occurs in the case where an intermediate level is displayed in a sub-pixel. Thus, the rewriting period of the sub-pixels is generally determined using the case where an input signal corresponding to an intermediate level is input to the sub-pixels as a reference. In other words, when a region having the largest change in transmittance of a liquid crystal element is used as a reference, the rewriting period of the sub-pixels is generally determined so that flickers are not generated in the reference.

Note that the normally white liquid crystal element is described here as an example; however, the same can be applied to a normally black liquid crystal element.

There are display devices which mainly display text data or the like. Specifically, in a display device which is connected to a word processor, a personal computer executing spreadsheet, or the like, still images such as text data are displayed relatively frequently.

The number of intermediate levels of a still image such as text data is small. Pixels provided in a display region of the display device or sub-pixels thereof each perform display with two gray scales, so that such an image can be displayed.

Specifically, a blue sub-pixel, a green sub-pixel, and a red sub-pixel each show the corresponding color or black. By combination of these, blue, green, red, cyan, yellow, magenta, black, or white can be displayed.

In such a case of displaying an image not including intermediate levels, unlike in the case of displaying an image including intermediate levels, the rewriting period of the sub-pixels does not have to be determined based on the intermediate levels in which the transmittance is easily changed.

One object of one embodiment of the present invention is to provide a novel display device which has a high aperture ratio and in which generation of flickers caused by rewriting pixels is reduced. Further, one object of one embodiment of the present invention is to provide a novel method for driving the display device which has a high aperture ratio and in which generation of flickers caused by rewriting pixels is reduced.

One embodiment of the present invention is made with a focus on lower frequency of rewriting images in the case of displaying a 2-gray-scale still image than the case of displaying a multi-gray-scale still image including intermediate levels. This leads to a method for driving a display device having a structure exemplified in this embodiment.

A display device of one embodiment of the present invention includes a step of determining whether displayed image data is two-valued still image data or multivalued still image data and a step of rewriting (refreshing) the two-valued still image data with lower frequency than the multivalued still image data. Alternatively, a display device of one embodiment of the present invention includes a mode for displaying two-valued still image data and a mode for displaying multivalued still image data. In the mode for displaying two-valued still image data, the rewriting (refresh) of the two-valued still image data is performed with lower frequency than the rewriting (refresh) of the multivalued still image data.

### One Embodiment of Present Invention

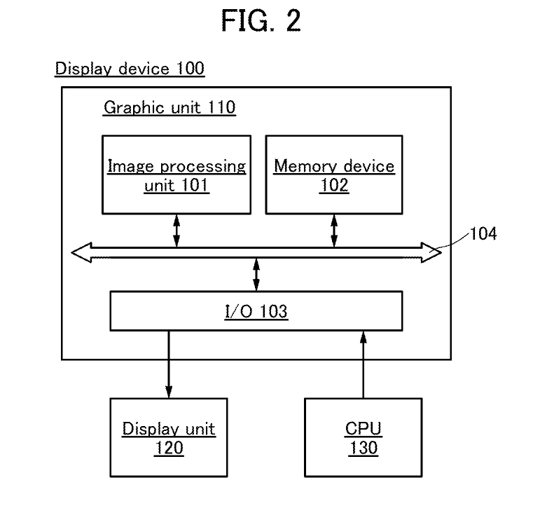

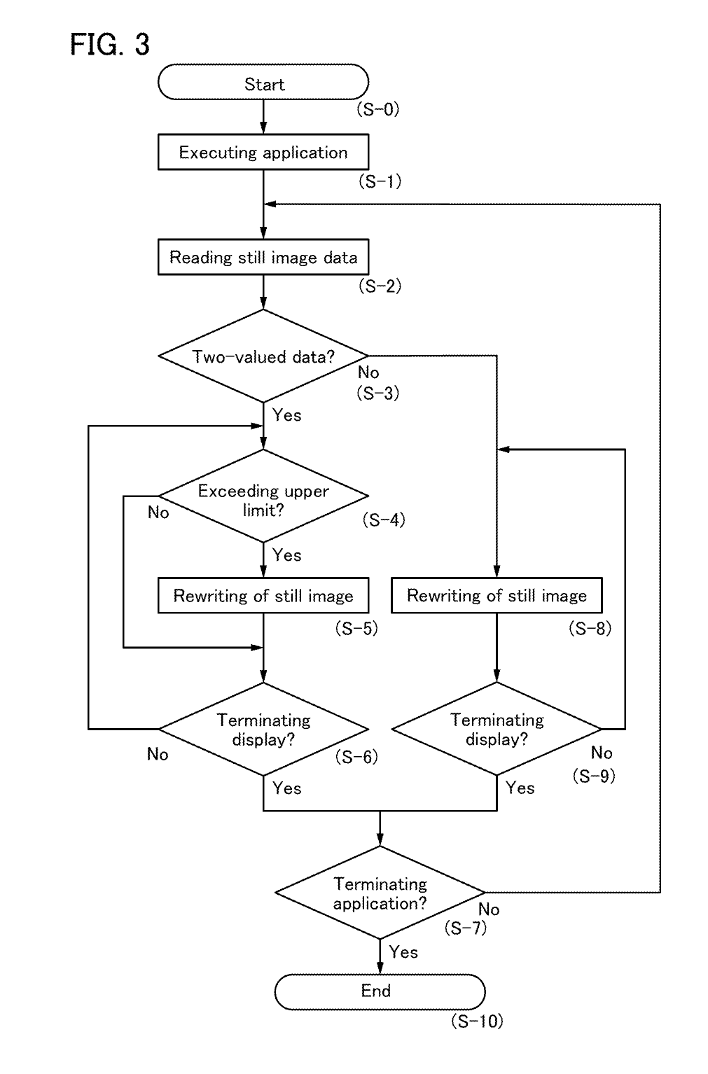

In this embodiment, a structure of a display device of one embodiment of the present invention is described with reference to FIG. 2 and FIG. 3. Specifically, a structure of a display device which operates by determining whether an input image signal is two-valued still image data or multivalued still image data is described.

FIG. 2 is a block diagram illustrating a structure of a display device of one embodiment of the present invention.

FIG. 3 is a flow chart illustrating a driving method of a display device of one embodiment of the present invention.

### <Display Device>

A display device 100 of one embodiment of the present invention includes a graphic unit 110, a display unit 120, and a central processing unit (CPU) 130 (see FIG. 2).

### <<Central Processing Unit (CPU)>>

The central processing unit (CPU) 130 executes a program and outputs image data.

### <<Graphic Unit>>

Image data is input to the graphic unit 110.

The graphic unit 110 can output an image signal, a synchronization signal such as a vertical synchronization signal or a horizontal synchronization signal, a clock signal, or the like to the display unit 120.

Further, the graphic unit 110 outputs a start pulse signal to the display unit 120. Note that the graphic unit 110 can output the start pulse signals with various frequencies. For example, in the case of displaying the two-valued still image, in order to reduce the frequency of rewriting of the two-valued still image data as compared to that of the multivalued still image data, the frequency of outputting the start pulse signal can be reduced.

The graphic unit 110 includes an image processing unit 101, a memory device 102, an input/output interface (I/O) 103, and a transmission path 104.

The transmission path 104 connects the image processing unit 101, the memory device 102, and the I/O 103, and transmits information. For example, image data is input from the I/O 103, and is transmitted to the image processing unit 101 and the memory device 102 through the transmission path 104.

The memory device 102 can store image data of at least one frame. The memory device 102 can store image data of at least the previous one frame.

The image processing unit 101 performs arithmetic processing on image data input from the central processing unit (CPU) 130, and gives instructions for output of the image data and a control signal including a start pulse to the display unit 120.

Further, for example, the image processing unit 101 can read setting information or the like stored in part of image data (e.g., a header portion), and can give instructions for output of a control signal to the display unit 120.

Further, for example, the image processing unit 101 can compare an input image signal with image data of the previous frame stored in the memory device 102 so as to determine whether or not they match each other.

Further, the image processing unit 101 can determine whether the image data input from the central processing unit 130 is two-valued still image data or multivalued still image data.

Further, the image processing unit 101 can determine whether or not the value of the counter operated by a program exceeds a predetermined upper limit.

### <<Display Unit>>

The display unit 120 can perform display in accordance with a variety of signals input from the graphic unit 110.

For example, when the start pulse signal is input, scanning for one frame is started, and rewriting of display corresponding to the image signal is performed. Further, in the case where the start pulse signal is not input, scanning is not performed, and rewriting of display is not performed.

That is the description of examples of the hardware structure of the display device 100.

### <Method for Driving Display Device>

The operation of a display device of one embodiment of the present invention is described with the flow chart in FIG. 3. First, the display device starts display.

### <<First Step>>

In a first step (S-1), application is read and executed.

### <<Second Step>>

In a second step (S-2), still image data is read.

### <<Third Step>>

In a third step (S-3), whether the read still image data is two-valued still image data or multivalued still image data is determined. In the case of the two-valued still image data, the operation proceeds to a fourth step (S-4); and in the case of the multivalued still image data, the operation proceeds to an eighth step (S-8).

As the method for determining whether the still image data is two-valued still image data or multivalued still image data, information which is written to part of the still image data (e.g., a header portion) in advance may be analyzed, or gray scale information included in still image data may be analyzed. The still image data having the information about whether or not the multivalued still image data is included can be referred to as metafile.

### <<Fourth Step>>

In the fourth step (S-4), whether or not the value of the counter exceeds a predetermined upper limit is determined. In the case of exceeding the upper limit, the value of the counter is reset to an initial value and the operation proceeds to a fifth step (S-5); and in the case of not exceeding the upper limit, count-up is performed and the operation proceeds to a sixth step (S-6).

Note that the upper limit of the value of the counter may be included in the part of the still image data (e.g., the header portion) or a configuration file of application in advance, and the user may set the upper limit as appropriate.

### <<Fifth Step>>

In the fifth step (S-5), rewriting operation of still images is performed.

The rewriting operation can be performed by a G start pulse signal which is output from the graphic unit 110 in accordance with an instruction from the image processing unit 101, for example. Scanning of a scan line can be started by the G start pulse signal. The details of the rewriting operation are described in Embodiment 2.

### <<Sixth Step>>

In the sixth step (S-6), whether or not display of the still image is terminated is determined. In the case where display is terminated, the operation proceeds to a seventh step (S-7); and in the case where display is not terminated, the operation proceeds to the fourth step (S-4).

As the method for determining whether or not display is terminated, in addition to a method in which “the time until termination of display” is written to the part of the still image data (e.g., the header portion) in advance, and then determination whether or not the time passes is made, a method in which “an interrupt instruction for termination” input by the user through an input device is monitored may be used.

Further, in a method for performing the fourth step (S-4) to the sixth step (S-6) repeatedly, the frequency of rewriting still images displayed on the display unit can be adjusted using the upper limit set for the counter.

For example, in the case where the initial value of the counter is 0, if the upper limit is set 0, the operation always proceeds to the fifth step (S-5) after the fourth step (S-4). In such a manner, the rewriting operation can be performed with high frequency.

Further, in the case where the initial value of the counter is 0, if the upper limit is set n (n is a positive integer), the operation does not proceed to the fifth step (S-5) after the fourth step (S-4) is performed for the first time. Then, after the fourth step (S-4) is repeated n times, the operation proceeds to the fifth step (S-5). In such a manner, the frequency of the rewriting operation can be reduced. Specifically, the rewriting operation can be set such that, when the upper limit is 9, the rewriting operation is not performed for the first time to the ninth time and is performed for the tenth time.

As described above, when the upper limit set for the counter is greater than or equal to 1, eyestrain can be reduced. As a result, a novel display device in which generation of flickers caused by rewriting pixels is reduced can be provided. Further, a novel method for driving the display device in which generation of flickers caused by rewriting pixels is reduced can be provided.

### <<Seventh Step>>

In the seventh step (S-7), whether or not the application is terminated is determined. In the case where the application is terminated, the operation proceeds to a tenth step (S-10); and in the case where the application is not terminated, the operation proceeds to the second step (S-2).

As the method for determining whether or not application is terminated, in addition to a method in which “information that the application is terminated after termination of display” is written to the part of the still image data (e.g., the header portion) in advance, and then determination whether or not the information is written is made, a method in which “an interrupt instruction for termination” input by the user through an input device is monitored may be used.

### <<Eighth Step>>

In the eighth step (S-8), rewriting operation of the still image is performed.

The rewriting operation can be performed by the G start pulse signal which is output from the graphic unit 110 in accordance with an instruction from the image processing unit 101, for example. Scanning of a scan line can be started by the G start pulse signal. The details of the rewriting operation are described in Embodiment 2.

### <<Ninth Step>>

In a ninth step (S-9), whether or not display of the still images is terminated is determined. In the case where display is terminated, the operation proceeds to the seventh step (S-7); and in the case where display is not terminated, the operation proceeds to the eighth step (S-8).

As the method for determining whether or not display is terminated, in addition to a method in which “the time until termination of display” is written to the part of the still image data (e.g., the header portion) in advance, and then determination whether or not the time passes is performed, a method in which “an interrupt instruction for termination” input by the user through an input device is monitored may be used.

Further, in a method for performing the eighth step (S-8) and the ninth step (S-9) repeatedly, still images displayed on the display unit can be rewritten with high frequency.

In this case, the size of a capacitor of the sub-pixel provided in the display unit can be reduced. As a result, a novel display device which has a high aperture ratio can be provided. Further, a novel driving method of the display device which has a high aperture ratio can be provided.

A display device of one embodiment of the present invention determines whether an input image signal is two-valued still image data or multivalued still image data. Accordingly, the rewriting period in the case of displaying two-valued still image data and the rewriting period in the case of displaying multivalued still image data can differ from each other. Specifically, two-valued still image data is displayed for a long rewriting period as compared to the case of displaying multivalued still image data. As a result, a novel display device in which flickers are not observed in the case of displaying either two-valued still image data or multivalued still image data can be provided.

### Embodiment 2

In this embodiment, examples of a semiconductor device having a display function (also referred to as a display device) whose refresh rate can be changed and a method for driving the semiconductor device are described with reference to drawings.

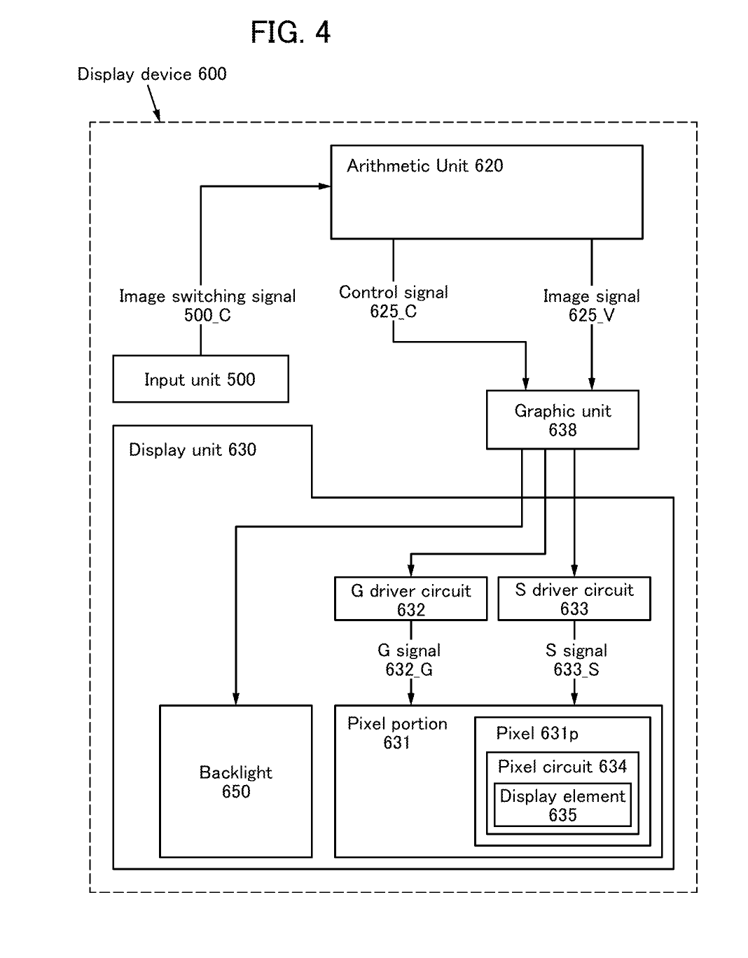

FIG. 4 is a block diagram illustrating a structure of a display device described in this embodiment.

### <1. Structure of Display Device>

A display device 600 in FIG. 4 includes at least an arithmetic unit 620, a graphic unit 638, and a display unit 630. The display unit 630 includes a pixel portion 631, pixel circuits 634 which hold first driving signals (also referred to as S signals) 633_S input and include display elements 635 displaying an image on the pixel portion 631 in accordance with the S signals 633_S, a first driver circuit (also referred to as S driver circuit) 633 which outputs the S signals 633_S to the pixel circuits 634, and a second driver circuit (also referred to as G driver circuit) 632 which outputs second driving signals (also referred to as G signals) 632_G for selecting the pixel circuits 634 to the pixel circuits 634.

The G driver circuit 632 includes a first mode in which the G signals 632_G are output with a frequency of greater than or equal to 30 times per second, preferably greater than or equal to 60 times per second and less than 960 times per second, and a second mode in which the G signals 632_G are output with a frequency of greater than or equal to once per day and less than once per 0.1 seconds, preferably greater than or equal to once per hour and less than once per second.

Note that the display device described in Embodiment 1 includes a structure in which the image processing unit 101 determines whether or not the value of the counter operated by a program exceeds the predetermined upper limit. In this structure, to increase or decrease the predetermined value can control the frequency with which still images are rewritten by the graphic unit 110. In contrast, the G driver circuit 632 in the display device described in this embodiment is provided in advance with modes which have different rewriting frequencies. In the G driver circuit 632, the first mode and the second mode are switched in response to an input start pulse signal SP for the G driver circuit.

The pixel circuit 634 is provided in a pixel 631p. A plurality of pixels 631p is provided in the pixel portion 631. The pixel portion 631 is provided in the display unit 630.

The arithmetic unit 620 outputs a control signal 625_C and an image signal 625_V.

A control unit 610 includes the graphic unit 638. The graphic unit 638 controls the S driver circuit 633 and the G driver circuit 632.

In the case where a liquid crystal element is used as the display element 635, the display unit 630 is provided with a backlight 650. The backlight 650 supplies light to the pixel portion 631 provided with the liquid crystal element.

The display device 600 can change the frequency of selecting one of a plurality of scan lines provided in the pixel portion 631 with the use of the G signals 632_G output from the G driver circuit 632. As a result, the display device 600 which has a display function in which eyestrain of the user of the display device is reduced can be provided.

Although the block diagram shows elements classified according to their functions in independent blocks, it may be practically difficult to completely separate the elements according to their functions and, in some cases, one element may be involved in a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. Further, in a p-channel transistor, a terminal to which a lower potential is applied is called a drain, and a terminal to which a higher potential is applied is called a source. In this specification, although connection relation of the transistor is described assuming that the source and the drain are fixed in some cases for convenience, actually, the names of the source and the drain interchange with each other depending on the relation of the potentials.

Note that in this specification, a “source” of a transistor means a source region that is part of a semiconductor film serving as an active layer or a source electrode connected to the semiconductor film. Similarly, a “drain” of a transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected in parallel with each other means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, a connection state means not only a state of a direct connection but also a state of indirect connection through a circuit element such as a wiring, a resistor, a diode, or a transistor so that current, a potential, or voltage can be supplied or transmitted.

In this specification, even when different components are connected to each other in a circuit diagram, there is actually a case where one conductive film has functions of a plurality of components such as a case where part of a wiring serves as an electrode. The term “connection” in this specification also means such a case where one conductive film has functions of a plurality of components.

Elements included in the display device of one embodiment of the present invention are described below.

### <2-1. Display Unit>

The display unit 630 includes the pixel portion 631 including the display element 635 in each pixel and driver circuits such as the S driver circuit 633 and the G driver circuit 632. The pixel portion 631 includes the plurality of pixels 631p each provided with the display element 635 (see FIG. 4).

The display unit 630 is provided with the image signal 625_V; a power source potential; an S driver circuit start pulse signal SP, an S driver circuit clock signal CK and a latch signal LP that control the operation of the S driver circuit 633; a G driver circuit start pulse signal SP, a G driver circuit clock signal CK and a pulse width control signal PWC that control the operation of the G driver circuit 632; and the like.

When the G driver circuit start pulse signal SP is input to the G driver circuit 632, the G driver circuit 632 outputs the G signals 632_G for driving the pixel portion. In contrast, when the G driver circuit start pulse signal SP is not input to the G driver circuit 632, the G driver circuit 632 does not output the G signals 632_G for driving the pixel portion.

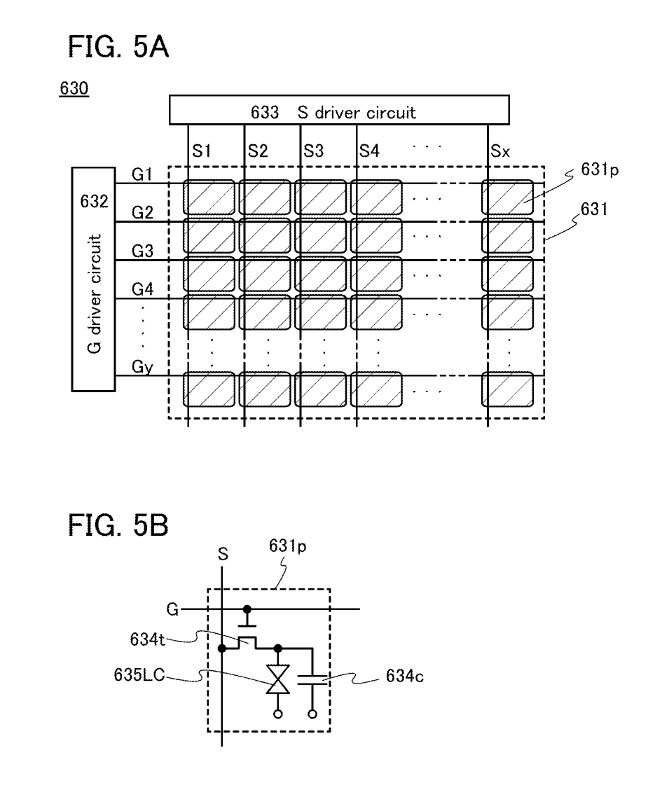

FIG. 5A illustrates an example of a structure of the display unit 630.

In the display unit 630 in FIG. 5A, the plurality of pixels 631p, a plurality of scan lines G for selecting the pixels 631p row by row, and a plurality of signal lines S for supplying the S signals 633_S generated from the image signals 625_V to the selected pixels 631p are provided in the pixel portion 631.

The input of the G signals 632_G to the scan lines G is controlled by the G driver circuit 632. The input of the S signals 633_S to the signal lines S is controlled by the S driver circuit 633. Each of the plurality of pixels 631p is connected to at least one of the scan lines G and at least one of the signal lines S.

Note that the kinds and number of the wirings in the pixel portion 631 can be determined by the structure, number, and arrangement of the pixels 631p. Specifically, in the pixel portion 631 illustrated in FIG. 5A, the pixels 631p are arranged in a matrix of x columns and y rows, and the signal lines S1 to Sx and the scan lines G1 to Gy are provided in the pixel portion 631.

### <2-1-1. Pixel>

Each of the pixels 631P includes the display element 635 and the pixel circuit 634 including the display element 635.

### <2-1-2. Pixel Circuit>

In this embodiment, as an example of the pixel circuit 634, a structure in which a liquid crystal element 635LC is used as the display element 635 is illustrated in FIG. 5B.

The pixel circuit 634 includes a transistor 634t for controlling supply of the S signals 633_S to the liquid crystal element 635LC. An example of connection relation between the transistor 634t and the display element 635 is described.

A gate of the transistor 634t is connected to any one of the scan lines G1 to Gy. One of a source and a drain of the transistor 634t is connected to any one of the signal lines S1 to Sx. The other of the source and the drain of the transistor 634t is connected to the first electrode of the display element 635.

Note that the pixel 631p may include other circuit elements such as a transistor, a diode, a resistor, a capacitor, and an inductor as needed, in addition to a capacitor 634c for holding voltage between a first electrode and a second electrode of the liquid crystal element 635LC.

In the pixel 631p illustrated in FIG. 5B, one transistor 634t is used as a switching element for controlling input of the S signals 633_S to the pixel 631p. A plurality of transistors serving as one switching element can be used for the pixel 631p. In the case where the plurality of transistors serves as one switching element, the plurality of transistors may be connected to each other in parallel, in series, or in combination of parallel connection and series connection.

Note that the size of the capacitor 634c may be adjusted as appropriate. For example, in the second mode described later, the capacitor 634c is provided in the case where the S signals 633_S are held for a relatively long period (specifically, 1/60 sec or longer). The capacitance of the pixel circuit 634 may be adjusted using a component other than the capacitor 634c. For example, a virtual capacitor may be formed by a structure in which the first electrode and the second electrode of the liquid crystal element 635LC are provided to overlap with each other.

The structure of the pixel circuit 634 may be selected depending on the kind of the display element 635 or the driving method.

<2-1-2a. Display Element>

The liquid crystal element 635LC includes a first electrode, a second electrode, and a liquid crystal layer including a liquid crystal material to which the voltage between the first electrode and the second electrode is applied. In the display element 635LC, the alignment of liquid crystal molecules is changed in accordance with the level of voltage applied between the first electrode and the second electrode, so that the transmittance is changed. Accordingly, the transmittance of the display element 635 is controlled by the potential of the S signal 633_S; thus, gradation can be expressed.

The display element 635 is not limited to the liquid crystal element 635LC. As the display element 635, various display elements such as an OLED element which generates luminescence (electroluminescence) by application of an electric field and electronic ink using electrophoresis can be used.

<2-1-2b. Transistor>

The transistor 634t controls whether or not to supply the potential of the signal line S to the first electrode of the display element 635. A predetermined reference potential Vcom is supplied to the second electrode of the display element 635.

As a preferable transistor for a display device to which the driving method of a display device of one embodiment of the present invention can be applied, a transistor using an oxide semiconductor can be used. The details of the transistor using an oxide semiconductor are described in Embodiments 4 and 5.

### <2-2. Graphic Unit>

The image signal 625_V, the control signal 625_C including a synchronization signal (e.g., a vertical synchronization signal or a horizontal synchronization signal), or the like which is generated by the arithmetic unit 620 is input to the graphic unit 638 (see FIG. 4).

The graphic unit 638 also has a function of generating control signals or the like such as an S driver circuit start pulse signal SP, a latch signal LP, and a pulse width control signal PWC, in addition to a G driver circuit start pulse signal SP, by using a synchronizing signal such as a vertical synchronizing signal or a horizontal synchronizing signal and supplying the control signals or the like to the display unit 630. A control signal such as a clock signal CK is also supplied from the graphic unit 638 to the display unit 630.

Further, the graphic unit 638 may be provided with an inversion control circuit to have a function of inverting the polarity of the image signal 625_V at a timing notified by the inversion control circuit. Specifically, the polarity of the image signal 625_V may be inverted in the graphic unit 638, or may be inverted in the display unit 630 in accordance with an instruction from the graphic unit 638.

The inversion control circuit has a function of determining timing of inverting the polarity of the image signal 625_V by using a synchronizing signal. For example, the inversion control circuit includes a counter and a signal generation circuit.

The counter has a function of counting the number of frame periods by using the pulse of a horizontal synchronizing signal.

The signal generation circuit has a function of notifying timing of inverting the polarity of the image signal 625_V to the graphic unit 638 so that the polarity of the image signal 625_V is inverted every plural consecutive frame periods by using information on the number of frame periods that is obtained in the counter.

### <2-3. Arithmetic Unit>

The arithmetic unit 620 generates the image signals 625_V to be input to the display unit 630. Note that the image signals 625_V may be directly input to the graphic unit 638.

Here, a structure in which the arithmetic unit 620 outputs the control signal 625_C including a mode switching signal, and the mode switching signal included in the control signal 625_C is input to the graphic unit 638 may be employed. The graphic unit 638 can generate a control signal including the start pulse signal SP for the G driver circuit in response to the control signal 625_C.

For example, the arithmetic unit 620 may output the control signal 625_C including the mode switching signal in response to an image switching signal 500_C input from an input unit 500.

For the input unit 500, various human interfaces can be used. In addition to a keyboard, a mouse, and a touch panel, for example, a sensor sensing gestures, eye movements, or the like can be used for the input unit 500.

For example, the image switching signal 500_C is input from the input unit 500. Accordingly, the graphic unit 638 can control the G driver circuit 632 to switch from the second mode to the first mode, change images by outputting G signals more than or equal to once, and then switch to the second mode.

The graphic unit 638 determines whether the input image signal 625_V is a moving image or a still image. In the case where the input image signal 625_V is a still image, the graphic unit 638 determines whether the input image signal 625_V is a two-valued image or a multivalued image. In the case where the input image signal 625_V is a moving image or a multivalued still image, the graphic unit 638 controls the G driver circuit 632 to operate in the first mode. In the case where the input image signal 625_V is a two-valued still image, the graphic unit 638 controls the G driver circuit 632 to operate in the second mode.

A method for determining whether the input image signal 625_V is a moving image or a still image is as follows. When the difference between the signal of one frame included in the image signal 625_V, and the signals of the previous and next frames is greater than a predetermined value, the signal is determined as a moving image. When the difference is smaller than or equal to the predetermined value, the signal is determined as a still image.

The structure may be used in which when the G driver circuit 632 is switched from the second mode to the first mode, the G signals 632_G are output the predetermined number of times, i.e., more than or equal to once, and then the G driver circuit 632 is switched to the second mode.

### <2-4. Backlight>

A plurality of light sources is provided in the backlight 650. The graphic unit 638 controls driving of the light sources in the backlight 650. A control circuit for controlling the driving of a light source may be provided between the graphic unit 638 and the backlight 650.

The light source in the backlight 650 can be a cold cathode fluorescent lamp, a light-emitting diode (LED), an OLED element generating luminescence (electroluminescence) when an electric field is applied thereto, or the like.

In particular, the intensity of blue light emitted by the light source is preferably weakened compared to that of light of any other color. Blue light included in light emitted by the light source reaches the retina in the eye without being absorbed by the cornea or the lens. Accordingly, weakening the intensity of blue light emitted by the light source compared to that of light of any other color makes it possible to reduce long-term effects of blue light on the retina (e.g., age-related macular degeneration), adverse effects of exposure to blue light until midnight on the circadian rhythm, and the like. In addition, a light source that mainly includes light with a wavelength longer than 400 nm and does not include light with a wavelength shorter than or equal to 400 nm (also referred to as UVA) is preferred.

### <3-1. Method for Writing S Signal to Pixel Portion>

An example of a method for writing the S signal 633_S to the pixel portion 631 exemplified in FIG. 5A is described. Specifically, a method for writing the S signal 633_S to each of the pixels 631p including a pixel circuit exemplified in FIG. 5B is described.

### <<Writing Signal to Pixel Portion>>

In a first frame period, the scan line G1 is selected by input of the G signal 632_G with a pulse to the scan line G1. In each of the plurality of pixels 631p connected to the selected scan line G1, the transistor 634t is turned on.

When the transistors 634t are on (in one line period), the potentials of the S signals 633_S generated from the image signals 625_V are applied to the signal lines S1 to Sx. Through each of the transistors 634t that is on, charge corresponding to the potential of the S signal 633_S is accumulated in the capacitor 634c and the potential of the S signal 633_S is applied to a first electrode of the liquid crystal element 635LC.

In a period during which the scan line G1 is selected in the first frame period, the S signals 633_S having a positive polarity are sequentially input to all the signal lines S1 to Sx. Thus, the S signals 633_S having a positive polarity are input to first electrodes G1S1 to G1Sx in the pixels 631p that are connected to the scan line G1 and any one of the signal lines S1 to Sx. Accordingly, the transmittance of the liquid crystal element 635LC is controlled by the potential of the S signal 633_S; thus, gradation is expressed by the pixels.

Similarly, the scan lines G2 to Gy are sequentially selected, and the pixels 631p connected to the scan lines G2 to Gy are sequentially subjected to the same operation as that performed while the scan line G1 is selected. Through the above operations, an image for the first frame can be displayed on the pixel portion 631.

Note that in one embodiment of the present invention, the scan lines G1 to Gy are not necessarily selected sequentially.

It is possible to employ dot sequential driving in which the S signals 633_S are sequentially input to the signal lines S1 to Sx from the S driver circuit 633 or line sequential driving in which the S signals 633_S are input all at once. Alternatively, a driving method in which the S signals 633_S are sequentially input every plural signal lines S may be employed.

In addition, the method for selecting the scan lines G is not limited to progressive scan; interlaced scan may be employed for selecting the scan lines G.

In given one frame period, the polarities of the S signals 633_S input to all the signal lines may be the same, or the polarities of the S signals 633_S to be input to the pixels may be inverted signal line by signal line.

<<Writing Signal to Pixel Portion Divided into Plurality of Regions>>

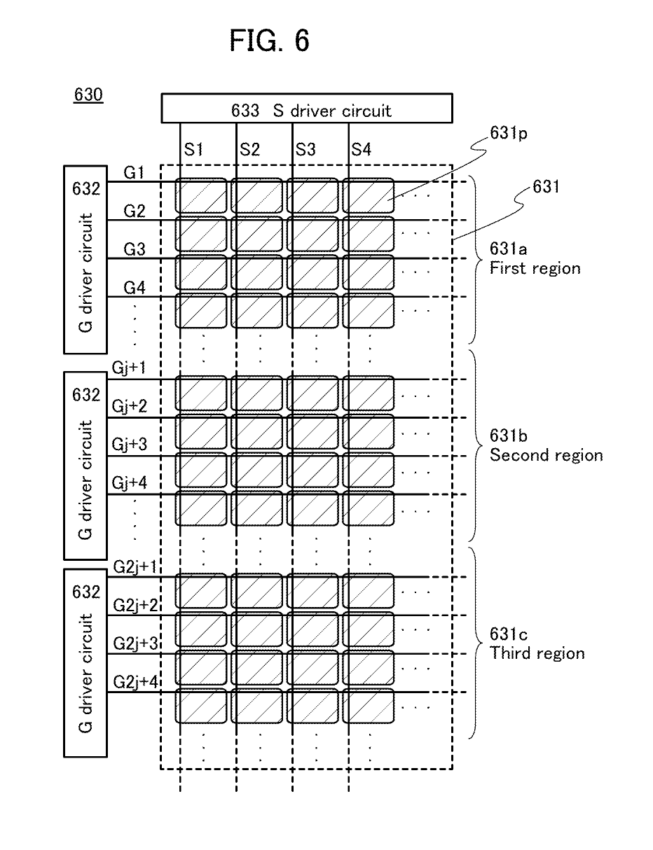

FIG. 6 illustrates a variation of the structure of the display unit 630.

In the display unit 630 in FIG. 6, the plurality of pixels 631p, the plurality of scan lines G for selecting the pixels 631p row by row, and the plurality of signal lines S for supplying the S signals 633_S to the selected pixels 631p are provided in the pixel portion 631 divided into plural regions (specifically, a first region 631a, a second region 631b, and a third region 631c).

The input of the G signals 632_G to the scan lines G in each region is controlled by the corresponding G driver circuit 632. The input of the S signals 633_S to the signal lines S is controlled by the S driver circuit 633. Each of the plurality of pixels 631p is connected to at least one of the scan lines G and at least one of the signal lines S.

Such a structure allows the pixel portion 631 to be divided into separately driven regions.

For example, the following operation is possible: coordinates specifying a region to which information is input are obtained using a touch panel as the input unit 500 when the information is input from the touch panel, and the G driver circuit 632 for driving a region corresponding to the coordinates is in the second mode and the other region is in the first mode. Thus, it is possible to stop the operation of the G driver circuit in a region to which information is not input from the touch panel, that is, a region where rewriting of the displayed image is not needed.

For example, regions displaying a two-valued still image by input image data are obtained, and only the G driver circuit 632 driving the regions may be in the second mode, and the G driver circuit 632 driving the other region may be in the first mode.

### <3-2. G Driver Circuit in First Mode and Second Mode>

The S signal 633_S is input to the pixel circuit 634 to which the G signal 632_G output from the G driver circuit 632 is input. While the G signal 632_G is not input, the pixel circuit 634 holds the potential of the S signal 633_S. In other words, the pixel circuit 634 holds a state where the potential of the S signal 633_S is written.

The pixel circuit 634 into which display data is written maintains a display state corresponding to the S signal 633_S. Note that to maintain a display state is to keep the amount of change in display state within a given range. This given range is set as appropriate, and is preferably set so that a user viewing displayed images can recognize the displayed images as the same image.

The G driver circuit 632 has the first mode and the second mode.

### <3-2-1. First Mode>

The G driver circuit 632 in the first mode outputs the G signals 632_G to pixels with a frequency of 30 times or more per second, preferably more than or equal to 60 times and less than 960 times per second.

The G driver circuit 632 in the first mode rewrites signals with speed at which a user cannot notice the change of images which occurs every signal rewriting. As a result, smooth moving images can be displayed.

### <3-2-2. Second Mode>

The G driver circuit 632 in the second mode outputs the G signals 632_G to pixels with a frequency of greater than or equal to once per day and less than once per 0.1 seconds, preferably greater than or equal to once per hour and less than once per second.

While the G signal 632_G is not input, the pixel circuit 634 keeps holding the S signal 633_S and maintains the display state corresponding to the potential of the S signal 633_S.

Accordingly, in the second mode, display without flickers due to rewriting of display by the pixel can be performed.

As a result, eyestrain on a user of the display device can be reduced.

The second mode can reduce power consumption as compared to the first mode. This is because the second mode has a period during which the G driver circuit 632 is not operated.

The above shows the structure having two modes: the first mode and the second mode. However, the structure may also have a third mode in which the G signals 632_G are output with lower frequency than the first mode and with greater frequency than the second mode. For example, the G driver circuit 632 may be driven in the first mode in the case of displaying a moving image, may be driven in the second mode in the case of displaying a two-valued still image, and may be driven in the third mode in the case of displaying a multivalued still image. For example, in the third mode, the G signals 632_G may be output with a frequency of greater than or equal to once per minute and less than once per second.

Note that the pixel circuit that is driven by the G driver circuit 632 having the second mode is preferably configured to hold the S signal 633_S for a long period. For example, the off-state leakage current of the transistor 634t is preferably as low as possible.

An example of a structure of the transistor 634t with low off-state leakage current is described in Embodiments 4 and 5.

This embodiment can be combined with any of the other embodiments disclosed in this specification as appropriate.

### Embodiment 3

In this embodiment, an image that can be displayed by a display device that is one embodiment of the present invention is described. In particular, an image switching method which reduces a user's eyestrain occurring when images are switched is described.

Quick switching of displays may cause eyestrain while the user is not aware of it. For example, the case of switching different scenes in a moving image, the case there of switching different still images, and the like can be given.

Thus, when discontinuous images are switched in a displayed image, it is preferable to display images by switching the images gradually (gently) and naturally, not by switching displays momentarily. For example, in the case where display is switched from the first image to the second image, which are not continuous images, a method such as fade-in or fade-out is preferably used. In particular, displays are preferably switched by temporarily overlapping the first image and the second image so that the first image is fade-out and at the same time the second image is fade-in (also referred to as cross-fade).

For example, in the case where two still image data are sequentially displayed, the first still image data is displayed at a low refresh rate, the first still image data is switched to the second still image data at a high refresh rate, and the second still image data is displayed at a low refresh rate again. At this time, when the images are switched, the above-described display switching is preferably performed.

An example of a method for switching an image A and an image B which are not continuous images is described below.

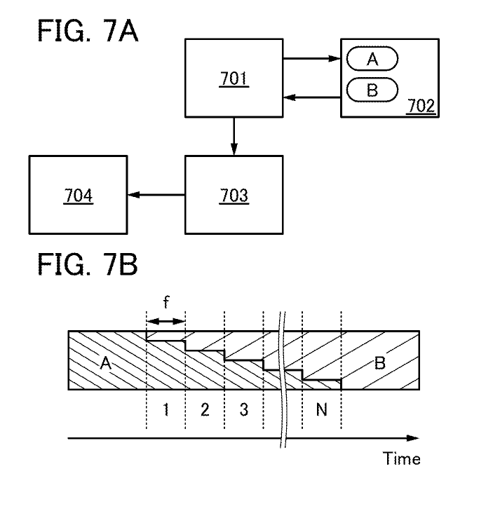

FIG. 7A is a block diagram showing a hardware structure in the case of image switching operation. FIG. 7A illustrates a structure including an arithmetic unit 701, a memory device 702, a graphic unit 703, and a display unit 704.

When images are switched, the arithmetic unit 701 stores each data of the image A and the image B from an external memory device or the like in the memory device 702.

The arithmetic unit 701 sequentially generates new image data based on each image data of the image A and the image B in accordance with the predetermined number of divisions, and outputs the generated image data to the graphic unit 703. The graphic unit 703 makes the display unit 704 display the input image data.

FIG. 7B is a schematic diagram illustrating image data used when images are gradually switched from the image A to the image B.

FIG. 7B shows a case where N image data (N is a natural number) are generated between the period that the image A is displayed and the period that the image B is displayed, and each image data is shown for f frame periods (f is a natural number). Thus, the period for the switching from the image A to the image B is N×f frame periods.

It is preferable that a user can freely set the parameters such as N and f. The arithmetic unit 701 obtains these parameters in advance, and generates image data in accordance with the parameters.

The i-th image data (i is an integer of greater than or equal to 1 and smaller than or equal to N) can be generated by obtaining weighted average of the image data of the image A and the image data of the image B using successively varying coefficients. For example, in a pixel, when the luminance (gray scale) in the case of displaying the image A is “a” and the luminance (gray scale) in the case of displaying the image B is “b”, the luminance (gray scale) “c” in the case of displaying the i-th image data is a value in Formula 1.

$$c = \frac{( N + 1 - i ) a + ib}{N + 1} \qquad [ Formula 1 ]$$

The image A is switched to the image B using the image data generated by such a method, so that not continuous images can be switched gradually (gently) and naturally.

Note that in Formula 1, in the case where “a”=0 in all pixels (the case where the image A is a black image), a black image is gradually switched to the image B (that is, fade-in). Further, in the case where “b”=0 in all pixels (the case where the image B is a black image), the image A is gradually switched to a black image (that is, fade-out).

The above describes a method for switching images by overlapping two images temporarily; however, a method in which two images are not overlapped may be employed.

In the case where two images are not overlapped with each other, a black image may be inserted while the image A is switched to the image B. In this case, the above image switching method can be used when the image A is switched to the black image and/or the black image is switched to the image B. The image inserted between the image A and the image B is not limited to a black image, and may be a single color image such as a white image or a multi-color image which is different from the image A and the image B.

When another image, in particular a single color image such as a black image, is inserted between the image A and the image B, a user can feel the timing of the switch of images more naturally; thus, images can be switched without giving the user stress.

### Embodiment 4

In this embodiment, a structural example of a display panel which can be used for a display unit of a display device of one embodiment of the present invention is described with reference to drawings.

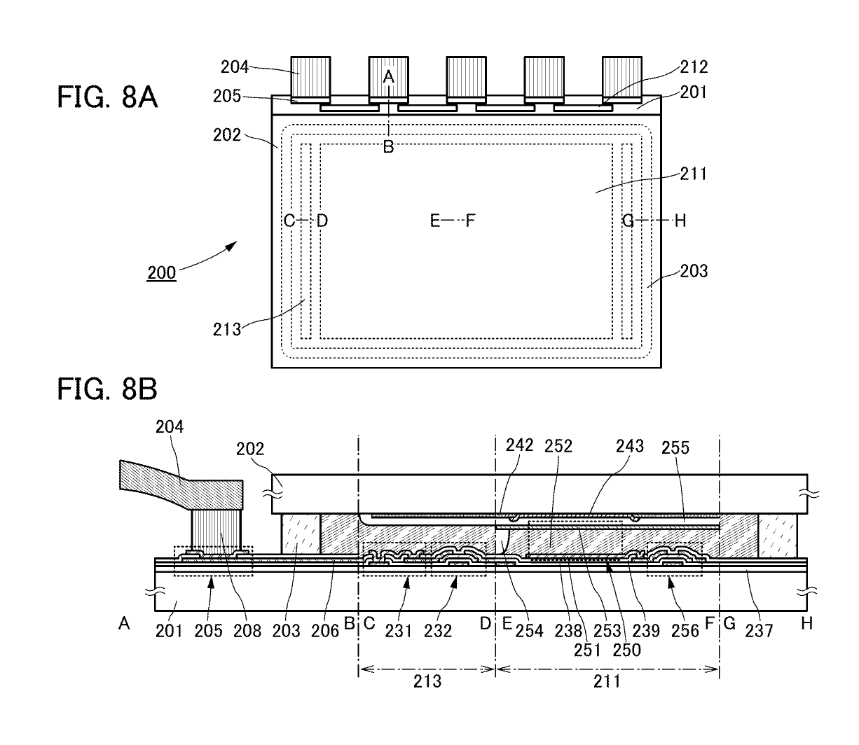

FIG. 8A is a schematic top view of a display panel 200 shown in this embodiment as an example.

The display panel 200 includes at least a pixel portion 211 including a plurality of pixels in a sealing region surrounded by a first substrate 201, a second substrate 202, and a sealant 203, and can include a gate driver circuit 213 in the sealing region. Further, the display panel 200 includes an external connection electrode 205 and an IC 212 serving as a source driver circuit over the first substrate 201 outside the sealing region. A power source potential or a signal for driving the pixel portion 211, the gate driver circuit 213, the IC 212, or the like can be input from an FPC 204 electrically connected to the external connection electrode 205.

FIG. 8B is a schematic cross-sectional view along line A-B, line C-D, line E-F, and line G-H in FIG. 8A. The line A-B is a cutting plane line which cuts a region including the FPC 204 and the sealant 203. The line C-D is a cutting plane line which cuts a region including the gate driver circuit 213. The line E-F is a cutting plane line which cuts a region including the pixel portion 211. The line G-H is a cutting plane line which cuts a region including the sealant 203.

The first substrate 201 and the second substrate 202 are sealed together with the sealant 203 in a region close to the peripheries of the first substrate 201 and the second substrate 202.

FIGS. 8A and 8B illustrate an example in which an n-channel transistor 232 is included as the gate driver circuit 213. Note that the gate driver circuit 213 may include a p-channel transistor. For example, the gate driver circuit 213 may include various CMOS circuits in which an n-channel transistor and a p-channel transistor are used in combination or a circuit in which p-channel transistors are used in combination. Although a driver-integrated display panel in which the gate driver circuit 213 is formed over the first substrate 201 is described in this structural example, one of or both the gate driver circuit and the source driver circuit may be provided over another substrate. For example, a driver circuit IC may be mounted by a COG method, or a flexible substrate (FPC) mounted with a driver circuit IC by a COF method may be mounted. This structural example shows a structure in which the IC 212 serving as a source driver circuit is provided over the first substrate 201 by a COG method.

Further, in the structure illustrated in FIGS. 8A and 8B, the gate driver circuit 213 includes a contact portion 231. In the contact portion 231, a wiring formed using the same conductive film as the gate electrode of the transistor is electrically connected to a wiring formed using the same conductive film as the source electrode or the drain electrode of the transistor through a wiring formed using the same conductive film as a first electrode 251 of a liquid crystal element 250 which is described later.

Note that there is no particular limitation on the structures of the transistors included in the pixel portion 211 and the gate driver circuit 213. For example, a top-gate transistor or a bottom-gate transistor may be used. Specifically, a forward planar type transistor, a reverse planar type transistor, a forward staggered type transistor, or a reverse staggered type transistor may be used. As a semiconductor material used for the transistors, for example, a semiconductor material such as silicon or germanium or an oxide semiconductor containing at least one of indium, gallium, and zinc may be used.

Further, there is no particular limitation on the crystallinity of a semiconductor used for the transistors, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case degradation of transistor characteristics can be reduced.

Typical examples of the oxide semiconductor containing at least one of indium, gallium, and zinc include an In—Ga—Zn-based metal oxide, and the like. An oxide semiconductor having a wider band gap and a lower carrier density than silicon is preferably used because off-state leakage current can be reduced. Details of preferred oxide semiconductors are described below in another embodiment.

FIG. 8B shows a cross-sectional structure of one pixel as an example of the pixel portion 211. The pixel portion 211 includes the liquid crystal element 250 to which a VA (vertical alignment) mode is applied.

Each pixel includes at least a transistor 256 for switching. Each pixel may include a storage capacitor not illustrated. In addition, the first electrode 251 electrically connected to a source electrode or a drain electrode of the transistor 256 is provided over an insulating layer 239.

The liquid crystal element 250 provided in the pixel includes the first electrode 251 provided over the insulating layer 239, a second electrode 253 provided over the second substrate 202, and a liquid crystal 252 provided between the first electrode 251 and the second electrode 253.

A light-transmitting conductive material is used for the first electrode 251 and the second electrode 253. As the light-transmitting conductive material, a conductive oxide such as indium oxide, indium tin oxide, indium zinc oxide, zinc oxide, or zinc oxide to which gallium is added, or graphene can be used.

Further, a color filter 243 and a black matrix 242 are provided over the second substrate 202 in at least a region overlapping with the pixel portion 211.

The color filter 243 is provided to adjust the color of light transmitted through a pixel to increase the color purity. For example, in a full-color display device using a white backlight, a plurality of pixels provided with color filters of different colors are used. In that case, the color filters may be those of three colors of red (R), green (G), and blue (B) or four colors (yellow (Y) in addition to these three colors). Further, a white (W) pixel may be added to R, G, and B pixels (and a Y pixel). That is, color filters of four colors (or five colors) may be used.

A black matrix 242 is provided between the adjacent color filters 243. The black matrix 242 blocks light emitted from an adjacent pixel, thereby preventing color mixture between the adjacent pixels. In one configuration, the black matrix 242 may be provided only between adjacent pixels of different emission colors and not between pixels of the same emission color. When the color filter 243 is provided so that its end portion overlaps with the black matrix 242, light leakage can be reduced. The black matrix 242 can be formed using a material that blocks light transmitted through the pixel, for example, a metal material or a resin material including a pigment. Note that it is preferable to provide the black matrix 242 also in a region overlapping with the gate driver circuit 213 or the like besides the pixel portion 211 as illustrated in FIG. 8B, in which case undesired leakage of guided light or the like can be prevented.

An overcoat 255 is provided so as to cover the color filter 243 and the black matrix 242. The overcoat 255 can suppress diffusion of impurities such as a pigment, which are included in the color filter 243 and the black matrix 242, into a liquid crystal 252. For the overcoat, a light-transmitting material is used, and an inorganic insulating material or an organic insulating material can be used.

The second electrode 253 is provided over the overcoat 255.

In addition, a spacer 254 is provided in a region where the overcoat 255 overlaps with the black matrix 242. The spacer 254 is preferably formed using a resin material because it can be formed thick. For example, the spacer 254 can be formed using a positive or negative photosensitive resin. When a light-blocking material is used for the spacer 254, the spacer 254 blocks light emitted from an adjacent pixel, thereby preventing color mixture between the adjacent pixels. Note that although the spacer 254 is provided on the second substrate 202 side in this structural example, it may be provided on the first substrate 201 side. Further, a structure may be employed in which spherical silicon oxide particles are used as the spacer 254 and the particles are scattered in a region where the liquid crystal 252 is provided.

An image can be displayed in the following way: an electric field is generated in a direction perpendicular to the electrode surface by application of voltage between the first electrode 251 and the second electrode 253, orientation of the liquid crystal 252 is controlled by the electric field, and polarization of light from a backlight provided outside the display device is controlled in each pixel.

An alignment film that controls orientation of the liquid crystal 252 may be provided on a surface in contact with the liquid crystal 252. A light-transmitting material is used for the alignment film.

In this structural example, a color filter is provided in a region overlapping with the liquid crystal element 250; thus, a full-color image with increased color purity can be displayed. With the use of a plurality of light-emitting diodes (LEDs) which emit light of different colors as a backlight, a time-division display method (a field-sequential driving method) can be employed. In the case of employing a time-division display method, the aperture ratio of each pixel or the number of pixels per unit area can be increased because neither color filters nor subpixels from which light of red (R), green (G), or blue (B), for example, is obtained are needed.

As the liquid crystal 252, a thermotropic liquid crystal, a low molecular liquid crystal, a polymer liquid crystal, a ferroelectric liquid crystal, an anti-ferroelectric liquid crystal, or the like can be used. Moreover, a liquid crystal exhibiting a blue phase is preferably used because an alignment film is not necessary and the viewing angle is wide. Note that a temperature range where the liquid crystal exhibits the blue phase can be enlarged with use of polymer (a polymer-stabilized blue phase). Specifically, a mixture of the above liquid crystal, a polymerization initiator, and monomers is injected or dropped and sealed between the substrates. After that, the monomers are polymerized, so that a temperature range where the liquid crystal exhibits the blue phase can be enlarged.

Although the liquid crystal element 250 having a VA mode is described in this structural example, the structure of the liquid crystal element is not limited to this example, and the liquid crystal element 250 using a different mode can be used. For example, an in-plane-switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

The first substrate 201 is provided with an insulating layer 237 in contact with an upper surface of the first substrate 201, an insulating layer 238 serving as a gate insulating layer of transistors, and the insulating layer 239 covering the transistors.

The insulating layer 237 is provided to prevent diffusion of impurities included in the first substrate 201. The insulating layers 238 and 239, which are in contact with semiconductor layers of the transistors, are preferably formed using a material which prevents diffusion of impurities that promote degradation of the transistors. For these insulating layers, for example, an oxide, a nitride, or an oxynitride of a semiconductor such as silicon or a metal such as aluminum can be used. Alternatively, a stack of such inorganic insulating materials or a stack of such an inorganic insulating material and an organic insulating material may be used. Note that the insulating layers 237 and 239 are not necessarily provided when not needed.

An insulating layer serving as a planarization layer covering a step caused by the transistor or the wiring provided in a lower layer may be provided between the insulating layer 239 and the first electrode 251. For such an insulating layer, it is preferable to use a resin material such as polyimide or acrylic. An inorganic insulating material may be used as long as high planarity can be obtained.

The structure illustrated in FIG. 8B makes it possible to reduce the number of photomasks required for forming the transistor and the first electrode 251 of the liquid crystal element 250 over the first substrate 201. More specifically, five kinds of photo masks may be used, which are used for a step of processing the gate electrode, a step of processing the semiconductor layer, a step of processing the source electrode and the drain electrode, a step of forming an opening in the insulating layer 239, and a step of processing the first electrode 251.

As illustrated in the contact portion 231 of FIG. 8B, an opening is provided in the insulating layer 238 and the insulating layer 239 in the same step so as to reach a wiring formed using the same conductive film as the gate electrode of the transistor. Further, an opening which is formed in the same step as the above is provided so as to reach a wiring formed using the same conductive film as the source electrode or the drain electrode of the transistor. A wiring formed using the same conductive film as the first electrode 251 of the liquid crystal element 250 may be provided to overlap with these two openings, so that the above two wirings may be electrically connected to each other.

A wiring 206 over the first substrate 201 is provided so as to extend to the outside of the region sealed with the sealant 203 and is electrically connected to the gate driver circuit 213. Part of an end portion of the wiring 206 forms part of the external connection electrode 205. In this structural example, the external connection electrode 205 is formed by a stack of a conductive film used for the source electrode and the drain electrode of the transistor and a conductive film used for the first electrode 251 of the liquid crystal element 250. The external connection electrode 205 is preferably formed by a stack of a plurality of conductive films as described above because electric resistance can be reduced and mechanical strength against a pressure bonding step performed on the FPC 204 or the like can be increased.

Although not illustrated, a wiring or an external connection electrode which electrically connects the IC 212 to the pixel portion 211 may also has a structure similar to that of the wiring 206 or the external connection electrode 205.

A connection layer 208 is provided in contact with the external connection electrode 205. The FPC 204 is electrically connected to the external connection electrode 205 through the connection layer 208. For the connection layer 208, a known anisotropic conductive film, a known anisotropic conductive paste, or the like can be used.

The end portions of the wiring 206 and the external connection electrode 205 are preferably covered with an insulating layer so that surfaces thereof are not exposed because oxidation of the surfaces and defects such as undesired short circuits can be suppressed.

This embodiment can be combined with any of the other embodiments disclosed in this specification as appropriate.

### Embodiment 5

An example of a semiconductor which is preferably used for the region where a channel is formed in the transistor which is shown as an example in the above embodiment is described below.

An oxide semiconductor has a wide energy gap of 3.0 eV or more. A transistor including an oxide semiconductor film obtained by processing the oxide semiconductor under appropriate conditions and by reducing the carrier density sufficiently can have much lower leakage current (off-state current) between a source and a drain in an off state than a conventional transistor including silicon.

In the case where an oxide semiconductor film is used for a transistor, the thickness of the oxide semiconductor film is preferably greater than or equal to 2 nm and less than or equal to 40 nm.

An oxide semiconductor applicable to a transistor preferably contains at least indium (In) or zinc (Zn). In particular, In and Zn are preferably contained. In addition, as a stabilizer for reducing variation in electrical characteristics of a transistor using the oxide semiconductor, one or more elements selected from gallium (Ga), tin (Sn), hafnium (Hf), zirconium (Zr), titanium (Ti), scandium (Sc), yttrium (Y), and a lanthanoid (such as cerium (Ce), neodymium (Nd), or gadolinium (Gd)) is preferably contained.

As the oxide semiconductor, for example, any of the following can be used: indium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

Here, an “In—Ga—Zn-based oxide” means an oxide containing In, Ga, and Zn as its main components and there is no particular limitation on the ratio of In, Ga, and Zn. Further, the In—Ga—Zn-based oxide may contain a metal element other than In, Ga, and Zn.

Alternatively, a material represented by 1 nMO₃(ZnO)ₙ, (m>0 is satisfied, and m is not an integer) may be used as the oxide semiconductor. Note that M represents one or more metal elements selected from Ga, Fe, Mn, and Co, or the above-described element as a stabilizer. Alternatively, as the oxide semiconductor, a material represented by In₂SnO₅(ZnO)ₙ (n>0 is satisfied, and n is an integer) may be used.

For example, an In—Ga—Zn-based oxide with an atomic ratio of In:Ga:Zn=1:1:1, In:Ga:Zn=1:3:1, In:Ga:Zn=1:6:4, In:Ga:Zn=1:9:6, In:Ga:Zn=3:1:2, or In:Ga:Zn=2:1:3, or an oxide with an atomic ratio close to the above atomic ratios can be used. Further, indium gallium oxide may be used.

When the oxide semiconductor film contains a large amount of hydrogen, the hydrogen and the oxide semiconductor are bonded to each other, so that part of the hydrogen becomes donors and generates electrons serving as carriers. As a result, the threshold voltage of the transistor shifts in the negative direction. Therefore, it is preferable that, after forming the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Accordingly, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment or treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

Thus, the transistor including an i-type or substantially i-type oxide semiconductor film can have extremely favorable off-state current characteristics. For example, the drain current at the time when the transistor including an oxide semiconductor film is in an off-state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. An off state of a transistor refers to a state where gate voltage is sufficiently lower than the threshold voltage in an n-channel transistor. Specifically, the transistor is in an off state when the gate voltage is lower than the threshold voltage by 1V or more, 2V or more, or 3V or more.

The oxide semiconductor film may be either single crystal or non-single-crystal. In the latter case, the oxide semiconductor may be either amorphous or polycrystal. Further, the oxide semiconductor may have either an amorphous structure including a portion having crystallinity or a non-amorphous structure.

Preferably, a CAAC-OS (c-axis aligned crystalline oxide semiconductor) film can be used as the oxide semiconductor film.

The CAAC-OS film is not completely single crystal nor completely amorphous. Note that in most cases, the crystal part fits inside a cube whose one side is less than 100 nm. From an observation image obtained with a transmission electron microscope (TEM), a boundary between an amorphous part and a crystal part in the CAAC-OS film is not clear. Further, with the TEM, a grain boundary in the CAAC-OS film is not found. Thus, in the CAAC-OS film, a reduction in electron mobility, due to the grain boundary, is suppressed.

In each of the crystal parts included in the CAAC-OS film, a c-axis is aligned in a direction parallel to a normal vector of a surface where the CAAC-OS film is formed or a normal vector of a surface of the CAAC-OS film, triangular or hexagonal atomic arrangement which is seen from the direction perpendicular to the a-b plane is formed, and metal atoms are arranged in a layered manner or metal atoms and oxygen atoms are arranged in a layered manner when seen from the direction perpendicular to the c-axis. Note that, among crystal parts, the directions of the a-axis and the b-axis of one crystal part may be different from those of another crystal part. In this specification, a simple term “perpendicular” includes a range from 85° to 95°. In addition, a simple term “parallel” includes a range from −5° to 5°.

In the CAAC-OS film, distribution of crystal parts is not necessarily uniform. For example, in the formation process of the CAAC-OS film, in the case where crystal growth occurs from a surface side of the oxide semiconductor film, the proportion of crystal parts in the vicinity of the surface of the oxide semiconductor film is higher than that in the vicinity of the surface where the oxide semiconductor film is formed in some cases. Further, when an impurity is added to the CAAC-OS film, the crystal part in a region to which the impurity is added becomes amorphous in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that when the CAAC-OS film is formed, the direction of c-axis of the crystal part is the direction parallel to a normal vector of the surface where the CAAC-OS film is formed or a normal vector of the surface of the CAAC-OS film. The crystal part is formed by film formation or by performing treatment for crystallization such as heat treatment after film formation.

In a transistor including the CAAC-OS film, change in electrical characteristics due to irradiation with visible light or ultraviolet light is small. Thus, the transistor has high reliability.

For example, a CAAC-OS film can be deposited by a sputtering method using a polycrystalline oxide semiconductor sputtering target. When ions collide with the sputtering target, a crystal region included in the sputtering target may be separated from the target along an a-b plane; in other words, a sputtered particle having a plane parallel to an a-b plane (flat-plate-like sputtered particle or pellet-like sputtered particle) may flake off from the sputtering target. In that case, the flat-plate-like sputtered particle or the pellet-like sputtered particle reaches a surface where the CAAC-OS film is to be deposited while maintaining its crystal state, whereby the CAAC-OS film can be deposited.

The flat-plate-like sputtered particle has, for example, an equivalent circle diameter of a plane parallel to the a-b plane of greater than or equal to 3 nm and less than or equal to 10 nm, and a thickness (length in the direction perpendicular to the a-b plane) of greater than or equal to 0.7 nm and less than 1 nm. Note that in the flat-plate-like sputtered particle, the plane parallel to the a-b plane may be a regular triangle or a regular hexagon. Here, the term “equivalent circle diameter of a plane” refers to the diameter of a perfect circle having the same area as the plane.

For the deposition of the CAAC-OS film, the following conditions are preferably used.

When the substrate temperature during the deposition is increased, migration of the flat-plate-like sputtered particles which have reached the substrate occurs, so that a flat plane of each sputtered particle is attached to the substrate. At this time, the sputtered particles are positively charged, thereby being attached to the substrate while repelling each other; thus, the sputtered particles are not stacked unevenly, so that a CAAC-OS film with a uniform thickness can be deposited. Specifically, the substrate temperature during the deposition is preferably higher than or equal to 100° C. and lower than or equal to 740° C., more preferably higher than or equal to 200° C. and lower than or equal to 500° C.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in a deposition chamber may be reduced. Furthermore, the concentration of impurities in a deposition gas may be reduced. Specifically, a deposition gas whose dew point is −80° C. or lower, preferably −100° C. or lower is used.

Furthermore, it is preferable that the proportion of oxygen in the deposition gas be increased and the power be optimized in order to reduce plasma damage at the deposition. The proportion of oxygen in the deposition gas is 30 vol % or higher, preferably 100 vol %.

After the CAAC-OS film is deposited, heat treatment may be performed. The temperature of the heat treatment is higher than or equal to 100° C. and lower than or equal to 740° C., preferably higher than or equal to 200° C. and lower than or equal to 500° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the CAAC-OS film in a short time. At the same time, the heat treatment in an inert atmosphere may generate oxygen vacancies in the CAAC-OS film. In such a case, the heat treatment in an oxidation atmosphere can reduce the oxygen vacancies. The heat treatment can further increase the crystallinity of the CAAC-OS film. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the CAAC-OS film in a shorter time.

As an example of the sputtering target, an In—Ga—Zn—O compound target is described below.

The In—Ga—Zn—O compound target, which is polycrystalline, is made by mixing InO_{X} powder, GaO_{Y} powder, and ZnO_{Z} powder in a predetermined molar ratio, applying pressure, and performing heat treatment at a temperature higher than or equal to 1000° C. and lower than or equal to 1500° C. Note that X, Y, and Z are each a given positive number. Here, the predetermined molar ratio of InO_{X} powder to GaO_{Y} powder and ZnO_{Z} powder is, for example, 1:1:1, 1:1:2, 1:3:2, 1:6:4, 1:9:6, 2:1:3, 2:2:1, 3:1:1, 3:1:2, 3:1:4, 4:2:3, 8:4:3, or a ratio close to these ratios. The kinds of powder and the molar ratio for mixing powder may be determined as appropriate depending on the desired sputtering target.

Alternatively, the CAAC-OS film may be formed by the following method.

First, a first oxide semiconductor film is formed to a thickness of greater than or equal to 1 nm and less than 10 nm. The first oxide semiconductor film is formed by a sputtering method. Specifically, the substrate temperature is set to be higher than or equal to 100° C. and lower than or equal to 500° C., preferably higher than or equal to 150° C. and lower than or equal to 450° C., and the proportion of oxygen in a deposition gas is set to be higher than or equal to 30 vol %, preferably 100 vol %.

Next, heat treatment is performed so that the first oxide semiconductor film becomes a first CAAC-OS film with high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the first oxide semiconductor film in a short time. At the same time, the heat treatment in an inert atmosphere may generate oxygen vacancies in the first oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the first oxide semiconductor film in a shorter time.

The first oxide semiconductor film with a thickness of greater than or equal to 1 nm and less than 10 nm can be easily crystallized by heat treatment as compared to the case where the first oxide semiconductor film has a thickness of greater than or equal to 10 nm.

Next, a second oxide semiconductor film having the same composition as the first oxide semiconductor film is formed to a thickness of greater than or equal to 10 nm and less than or equal to 50 nm. The second oxide semiconductor film is formed by a sputtering method. Specifically, the substrate temperature is set to be higher than or equal to 100° C. and lower than or equal to 500° C., preferably higher than or equal to 150° C. and lower than or equal to 450° C., and the proportion of oxygen in a deposition gas is set to be higher than or equal to 30 vol %, preferably 100 vol %.

Next, heat treatment is performed so that solid phase growth of the second oxide semiconductor film from the first CAAC-OS film occurs, whereby the second oxide semiconductor film is turned into a second CAAC-OS film having high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the second oxide semiconductor film in a short time. At the same time, the heat treatment in an inert atmosphere may generate oxygen vacancies in the second oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the second oxide semiconductor film in a shorter time.

In the above-described manner, a CAAC-OS film having a total thickness of 10 nm or more can be formed.

Further, the oxide semiconductor film may have a structure in which a plurality of oxide semiconductor films is stacked.

For example, a structure may be employed in which, between an oxide semiconductor film (referred to as a first layer for convenience) and a gate insulating film, a second layer which is formed using the constituent element of the first layer and whose electron affinity is lower than that of the first layer by 0.2 eV or more is provided. In this case, when an electric field is applied from a gate electrode, a channel is formed in the first layer, and a channel is not formed in the second layer. The constituent element of the first layer is the same as the constituent element of the second layer, and thus interface scattering hardly occurs at the interface between the first layer and the second layer. Accordingly, when the second layer is provided between the first layer and the gate insulating film, the field-effect mobility of the transistor can be increased.

Further, in the case where a silicon oxide film, a silicon oxynitride film, a silicon nitride oxide film, or a silicon nitride film is used as the gate insulating film, silicon contained in the gate insulating film enters the oxide semiconductor film in some cases. When the oxide semiconductor film contains silicon, reductions in crystallinity and carrier mobility of the oxide semiconductor film occur, for example. Thus, it is preferable to provide the second layer between the first layer and the gate insulating film in order to reduce the concentration of silicon in the first layer where a channel is formed. For the same reason, it is preferable to provide a third layer which is formed using the constituent element of the first layer and whose electron affinity is lower than that of the first layer by 0.2 eV or more so that the first layer is interposed between the second layer and the third layer.

Such a structure makes it possible to reduce and further prevent diffusion of impurities such as silicon to a region where a channel is formed, so that a highly reliable transistor can be obtained.

Note that in order to make the oxide semiconductor film a CAAC-OS film, the concentration of silicon contained in the oxide semiconductor film is set to lower than or equal to 2.5×10²¹/cm³, preferably lower than 1.4×10²¹/cm³, more preferably lower than 4×10¹⁹/cm³, still more preferably lower than 2.0×10¹⁸/cm³. This is because the field-effect mobility of the transistor may be reduced when the concentration of silicon contained in the oxide semiconductor film is higher than or equal to 1.4×10²¹/cm³, and the oxide semiconductor film may be made amorphous at the interface between the oxide semiconductor film and a film in contact with the oxide semiconductor film when the concentration of silicon contained in the oxide semiconductor film is higher than or equal to 4.0×10¹⁹/cm³. Further, when the concentration of silicon contained in the oxide semiconductor film is lower than 2.0×10¹⁸/cm³, further improvement in reliability of the transistor and a reduction in density of states (DOS) in the oxide semiconductor film can be expected. Note that the concentration of silicon in the oxide semiconductor film can be measured by secondary ion mass spectrometry (SIMS).

This embodiment can be combined with any of the other embodiments disclosed in this specification as appropriate.

### Embodiment 6

In this embodiment, examples of an electronic device provided with a display device manufactured using a manufacturing apparatus of one embodiment of the present invention is described with reference to drawings.

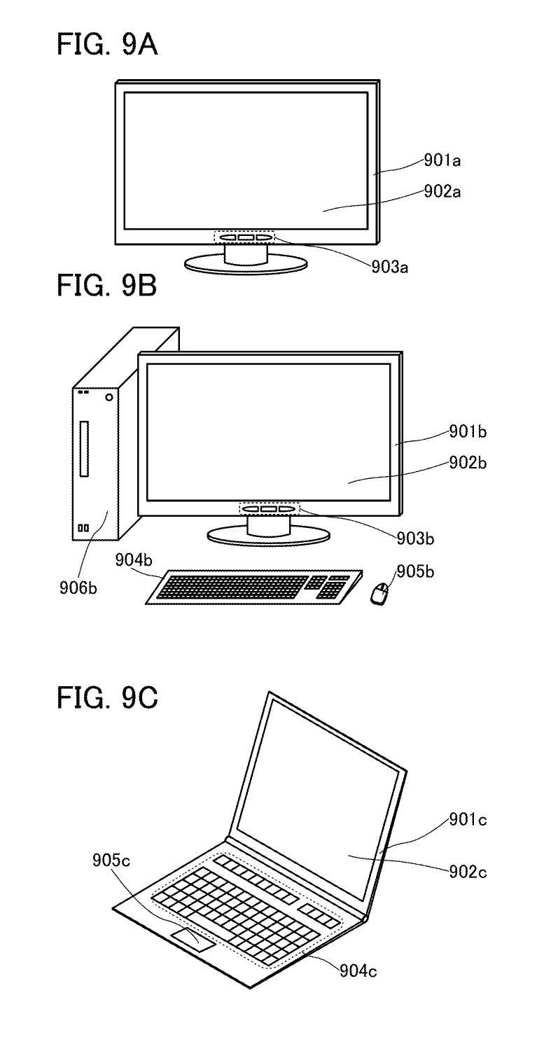

Examples of such an electronic device for which a display device of one embodiment of the present invention is used include: television sets (also called TV or television receivers); monitors for computers or the like; cameras such as digital cameras or digital video cameras; digital photo frames; mobile phones (also called cellular phones or portable telephones); portable game machines; portable information terminals; tablet information terminal; audio playback devices; and large game machines such as pachinko machines. Specific examples of these electronic devices are shown in FIGS. 9A to 9C.

FIG. 9A illustrates an electronic device as an example of a monitor.

The electronic device illustrated in FIG. 9A includes a housing 901a, a display portion 902a, and an input unit 903a.

The display portion 902a is incorporated in the housing 901a. The display portion 902a can display images. The housing 901a is supported by a stand provided at the bottom of the housing 901a.

Further, the input unit 903a is incorporated in the housing 901a. A user can input a variety of setting information using the input unit 903a.

At least the arithmetic unit, the memory device, and the graphic unit described in the above embodiment are provided in the housing 901a.

The electronic device illustrated in FIG. 9A can determine whether a displayed image is a moving image or a still image, and in the case where the image is a still image, the electronic device can determine whether the displayed image is a two-valued still image or a multivalued still image. In the case where the displayed image is a two-valued still image, the refresh rate is lowered, whereby a user's eyestrain can be reduced while image degradation is suppressed. Further, images can be switched naturally, so that the user's eyestrain caused by image switching can be reduced.

The electronic device illustrated in FIG. 9B is an example of a personal computer.

The electronic device illustrated in FIG. 9B includes a housing 901b including a display portion 902b, an input unit 903b incorporated in the housing 901b, a keyboard 904b, a mouse 905b, and a main body 906b.

At least the arithmetic unit, the memory device, and the graphic unit described in the above embodiment are provided in the main body 906b.

The keyboard 904b and the mouse 905b can be used as input units which are different from the input unit 903b.

The electronic device illustrated in FIG. 9B can determine whether a displayed image is a moving image or a still image, and in the case where the image is a still image, the electronic device can determine whether the displayed image is a two-valued still image or a multivalued still image. In the case where the displayed image is a two-valued still image, the refresh rate is lowered, whereby a user's eyestrain can be reduced while image degradation is suppressed. Further, images can be switched naturally, so that the user's eyestrain caused by image switching can be reduced.

The electronic device illustrated in FIG. 9C is an example of a note-book personal computer.

The electronic device illustrated in FIG. 9C includes a housing 901c. In the housing 901c, a display portion 902c, a keyboard 904c, and a pointing device 905c are incorporated.

At least the arithmetic unit, the memory device, and the graphic unit described in the above embodiment are provided in the housing 901c.

The electronic device illustrated in FIG. 9C can determine whether a displayed image is a moving image or a still image, and in the case where the image is a still image, the electronic device can determine whether the displayed image is a two-valued still image or a multivalued still image. In the case where the displayed image is a two-valued still image, the refresh rate is lowered, whereby a user's eyestrain can be reduced while image degradation is suppressed. Further, images can be switched naturally, so that the user's eyestrain caused by image switching can be reduced.

The electronic device of one embodiment of the present invention is not limited to the above structure, and may have any structure as long as at least the arithmetic unit, the memory device, and the graphic unit described in the above embodiment are included. The arithmetic unit, the memory device, and the graphic unit may be separately incorporated in different housings.

This embodiment can be combined with any of the other embodiments disclosed in this specification as appropriate.

### Embodiment 7

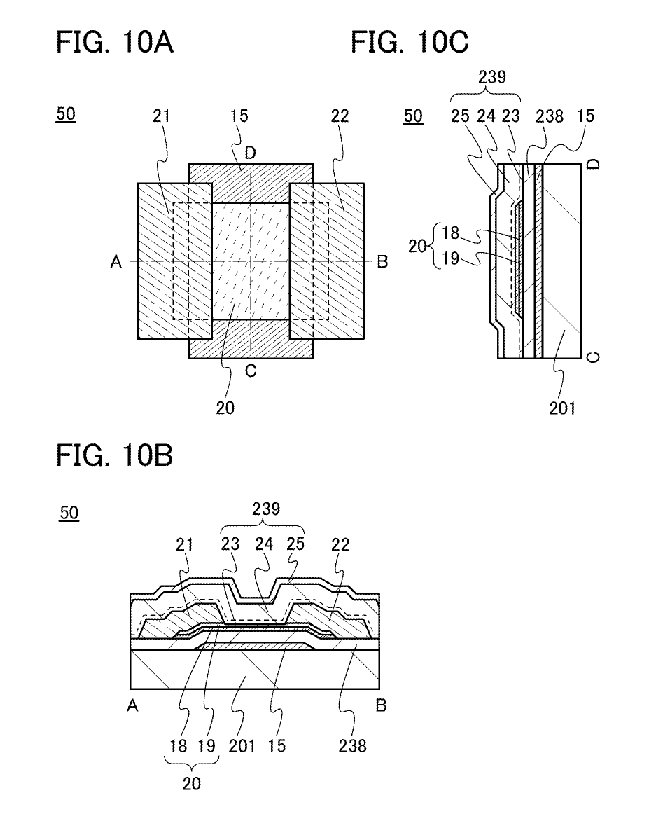

In this embodiment, a method for manufacturing a backplane (a substrate including transistors) of a display panel which can be used for a display device of one embodiment of the present invention is described with reference to FIGS. 10A to 10C, FIGS. 11A to 11D, and FIGS. 12A and 12B. This embodiment describes a case where an oxide semiconductor film is used as a semiconductor film of the transistor.

FIGS. 10A to 10C are a top view and cross-sectional views of the transistor 50 which can be used for the display panel 200. FIG. 10A is a top view of the transistor 50. FIG. 10B is a cross-sectional view along dashed-dotted line A-B in FIG. 10A. FIG. 10C is a cross-sectional view along dashed-dotted line C-D in FIG. 10A. Some components of the transistor 50 (e.g., the substrate 201, the insulating layer 238, the oxide insulating film 23, the oxide insulating film 24, and the nitride insulating film 25) are not illustrated in FIG. 10A for clarity.

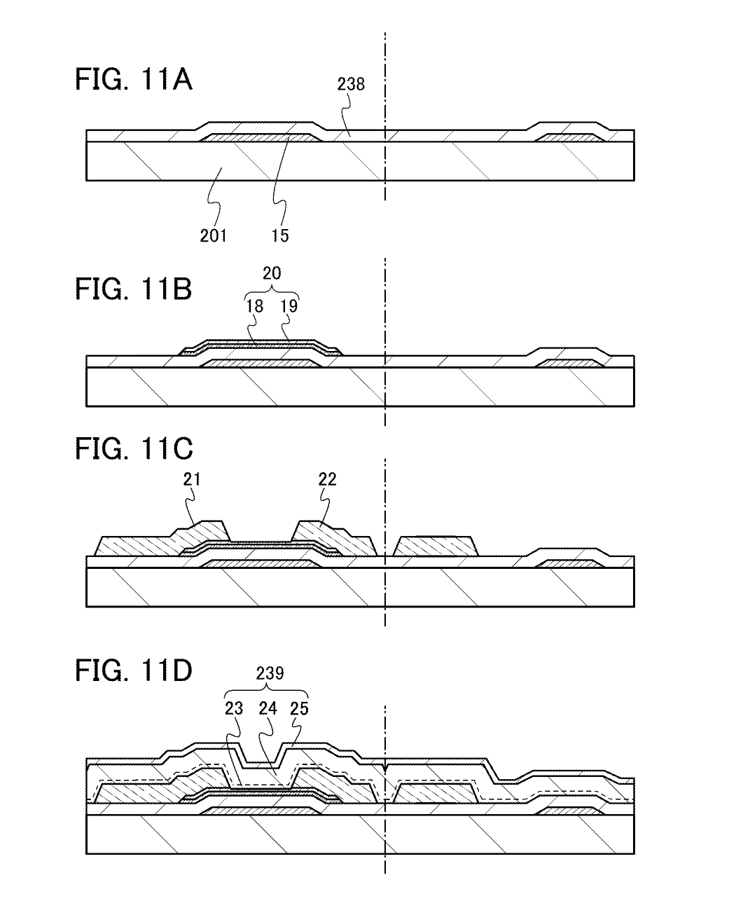

FIGS. 11A to 11D are cross-sectional views illustrating a method for manufacturing the transistor 50 illustrated in FIGS. 10A to 10C over the substrate 201.

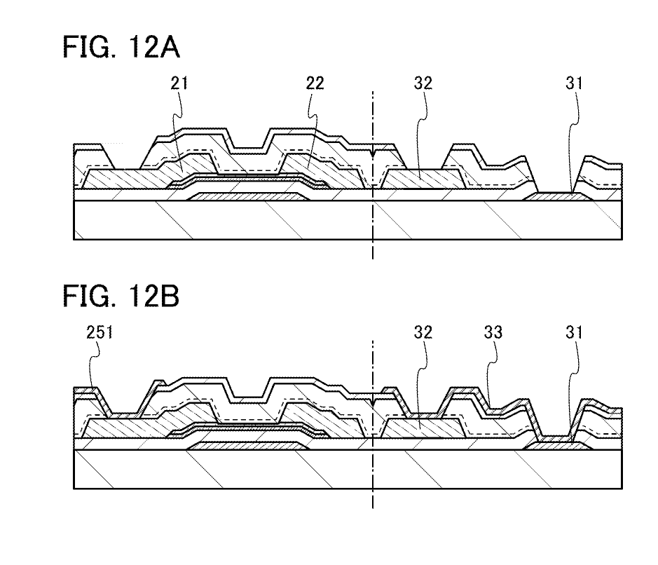

FIGS. 12A and 12B are cross-sectional views illustrating a method for forming the first electrode 251 after the transistor 50 is formed.

### <Transistor Including Oxide Semiconductor Film>

An oxygen defect is an example of defects causing poor electrical characteristics of the transistor including an oxide semiconductor film. For example, the threshold voltage of a transistor including an oxide semiconductor film with oxygen vacancies easily shifts in the negative direction, and such a transistor tends to be normally-on. This is because electric charges are generated owing to oxygen vacancies in the oxide semiconductor film, and the resistance is reduced. The transistor having normally-on characteristics causes various problems in that malfunction is likely to be caused when in operation and that power consumption is increased when not in operation. Further, the amount of change in electrical characteristics, typically threshold voltage, due to change over time or a stress test is increased, which is a problem.

As a cause of oxygen vacancies, damage generated in a step of manufacturing a transistor can be given. For example, when an insulating film or the like is formed over an oxide semiconductor film by a plasma CVD method, the oxide semiconductor film may be damaged depending on the formation conditions.

Further, not only oxygen vacancies but also impurities such as silicon or carbon which are constituent elements of the insulating film cause defects of electrical characteristics. Thus, entry of the impurities into the oxide semiconductor film makes the resistance of the oxide semiconductor film lower, so that the amount of change in electrical characteristics, typically threshold voltage, due to change over time or a stress test is increased, which is a problem.

### <Structure of Transistor>

The transistor 50 illustrated in FIGS. 10B and 10C includes a gate electrode 15 over the substrate 201. The transistor 50 further includes the insulating layer 238 over the substrate 201 and the gate electrode 15, a multi-layer film 20 overlapping with the gate electrode 15 with the insulating layer 238 interposed therebetween, and a pair of electrodes 21 and 22 in contact with the multi-layer film 20. The insulating layer 239 including an oxide insulating film 23, an oxide insulating film 24, and a nitride insulating film 25 is formed over the insulating layer 238, the multi-layer film 20, and the pair of electrodes 21 and 22.

The multi-layer film 20 in the transistor 50 described in this embodiment includes an oxide semiconductor film 18 and an oxide film 19 containing In or Ga. The oxide semiconductor film 18 serves as a channel region. The oxide insulating film 23 is formed in contact with the multi-layer film 20. The oxide insulating film 24 is formed in contact with the oxide insulating film 23. That is, the oxide film 19 containing In or Ga is provided between the oxide semiconductor film 18 and the oxide insulating film 23.

### <<Semiconductor Film>>

The oxide semiconductor film 18 is typically an In—Ga-based oxide, an In—Zn-based oxide, or an In-M-Zn-based oxide (M is Al, Ti, Ga, Y, Zr, La, Ce, Nd, or Hf).

When the oxide semiconductor film 18 is an In-M-Zn-based oxide, it is preferable that the proportion of In be lower than 50 atomic % and the proportion of M be higher than 50 atomic %, respectively. It is more preferable that the proportion of In be lower than 25 atomic % and the proportion of M be higher than 75 atomic %, respectively.

The energy gap of the oxide semiconductor film 18 is 2 eV or more, preferably 2.5 eV or more, more preferably 3 eV or more. In this manner, the off-state current of the transistor 50 can be reduced with the use of an oxide semiconductor having a wide energy gap.

The thickness of the oxide semiconductor film 18 is greater than or equal to 3 nm and less than or equal to 200 nm, preferably greater than or equal to 3 nm and less than or equal to 100 nm, more preferably greater than or equal to 3 nm and less than or equal to 50 nm.

The oxide film 19 containing In or Ga is typically an In—Ga-based oxide, an In—Zn-based oxide, or an In-M-Zn-based oxide (M is Al, Ti, Ga, Y, Zr, La, Ce, Nd, or Hf). The energy of the bottom of the conduction band of the oxide film 19 containing In or Ga is closer to a vacuum level than that of the oxide semiconductor film 18. The difference between the energy of the bottom of the conduction band of the oxide film 19 containing In or Ga and the energy of the bottom of the conduction band of the oxide semiconductor film 18 is typically greater than or equal to 0.05 eV, greater than or equal to 0.07 eV, or greater than or equal to 0.1 eV and smaller than or equal to 2 eV, smaller than or equal to 0.5 eV, or smaller than or equal to 0.4 eV.

When the oxide film 19 containing In or Ga is an In-M-Zn-based oxide, it is preferable that the proportion of In be higher than or equal to 25 atomic % and the proportion of M be lower than 75 atomic %. It is more preferable that the proportion of In be higher than or equal to 34 atomic % and the proportion of M be lower than 66 atomic %.

In the case where the oxide semiconductor film 18 and the oxide film 19 containing In or Ga are In-M-Zn-based oxide (M is Al, Ti, Ga, Y, Zr, La, Ce, Nd, or Hf), the atomic ratio of M (Al, Ti, Ga, Y, Zr, La, Ce, Nd, or Hf) in the oxide film 19 containing In or Ga is greater than that in the oxide semiconductor film 18. The atomic ratio of M in the oxide film 19 containing In or Ga is typically 1.5 times or more, preferably twice or more, more preferably three times or more as large as that in the oxide semiconductor film 18.

In the case where the oxide semiconductor film 18 and the oxide film 19 containing In or Ga are In-M-Zn-based oxide (M is Al, Ti, Ga, Y, Zr, La, Ce, Nd, or Hf), assuming that the atomic ratio in the oxide film 19 containing In or Ga is In:M:Zn=x₁:y₁:z₁ and the atomic ratio in the oxide semiconductor film 18 is In:M:Zn=x₂:y₂:z₂, y₁/x1 is greater than y_{z}/x₂, preferably y₁/x₁ is 1.5 times or more as large as y₂/x₂. It is more preferable that y₁/x₁ be twice or more as large as y₂/x₂. It is still more preferable that y₁/x₁ be three times or more as large as y₂/x₂. Here, in the oxide semiconductor film, y₂ is preferably larger than or equal to x₂ because the transistor including an oxide semiconductor film can have stable electrical characteristics. However, when y₂ is three times or more as large as x₂, the field-effect mobility of the transistor including an oxide semiconductor film is reduced; accordingly, y₂ is preferably smaller than three times x₂.

For example, for the oxide semiconductor film 18, In—Ga—Zn-based oxide with an atomic ratio of In:Ga:Zn=1:1:1 or 3:1:2 can be used. For the oxide film 19 containing In or Ga, In—Ga—Zn-based oxide with an atomic ratio of In:Ga:Zn=1:3:2, 1:6:4, or 1:9:6 can be used. Note that a proportion of each atom in the atomic ratio of the oxide semiconductor film 18 and the oxide film 19 containing In or Ga varies within a range of ±20% as an error.

Note that the composition is not limited to those described above, and a material having the appropriate composition may be used depending on needed semiconductor characteristics and electrical characteristics (e.g., field-effect mobility and threshold voltage) of the transistor. To obtain the needed semiconductor characteristics of the transistor, it is preferable that the carrier density, the impurity concentration, the defect density, the atomic ratio between a metal element and oxygen, the interatomic distance, the density, and the like of the oxide semiconductor film 18 be set to appropriate values.

The oxide film 19 containing In or Ga also serves as a film which relieves damage to the oxide semiconductor film 18 at the time of forming the oxide insulating film 24 which is formed later.

The thickness of the oxide film 19 containing In or Ga is greater than or equal to 3 nm and less than or equal to 100 nm, preferably greater than or equal to 3 nm and less than or equal to 50 nm.

When silicon or carbon which is one of elements belonging to Group 14 is contained in the oxide semiconductor film 18, oxygen vacancies are increased in the oxide semiconductor film 18 and the oxide semiconductor film 18 becomes an n-type. Thus, the concentration of silicon and carbon in the oxide semiconductor film 18 or in the vicinity of the interface between the oxide film 19 containing In or Ga and the oxide semiconductor film 18 is less than or equal to 2×10¹⁸ atoms/cm³, preferably less than or equal to 2×10¹⁷ atoms/cm³.

The oxide semiconductor film 18 and the oxide film 19 containing In or Ga may each be a film having an amorphous structure, a single crystal structure, or a polycrystalline structure or the above-described CAAC-OS (c-axis aligned crystalline oxide semiconductor) film. When at least the oxide semiconductor film 18 is a CAAC-OS film, the amount of change in electrical characteristics due to irradiation with visible light or ultraviolet light can be further reduced.

In the transistor 50 described in this embodiment, the oxide insulating film 23 is formed in contact with the multi-layer film 20 and the oxide insulating film 24 is formed in contact with the oxide insulating film 23.

### <<Insulating Film>>

The oxide insulating film 23 is an oxide insulating film through which oxygen penetrates. The oxide insulating film 23 also serves as a film which relieves damage to the multi-layer film 20 at the time of forming the oxide insulating film 24 which is formed later.

As the oxide insulating film 23, a silicon oxide film, a silicon oxynitride film, or the like having a thickness greater than or equal to 5 nm and less than or equal to 150 nm, preferably greater than or equal to 5 nm and less than or equal to 50 nm, can be used. Note that in this specification, a “silicon oxynitride film” refers to a film that includes more oxygen than nitrogen, and a “silicon nitride oxide film” refers to a film that includes more nitrogen than oxygen.

Further, it is preferable that the number of defects in the oxide insulating film 23 be small, and typically the spin density of a signal due to a dangling bond of silicon, which appears when g is 2.001, be lower than or equal to 3×10¹⁷ spins/cm³ by ESR measurement. This is because if the density of defects in the oxide insulating film 23 is high, oxygen is bonded to the defects and the amount of oxygen that passes through the oxide insulating film 23 is decreased.

Further, it is preferable that the number of defects at the interface between the oxide insulating film 23 and the multi-layer film 20 be small, and typically the spin density of a signal due to an oxygen vacancy in the multi-layer film 20, which appears when g is 1.93, be lower than or equal to 1×10¹⁷ spins/cm³, more preferably lower than or equal to the lower limit of detection by ESR measurement.

Note that all oxygen atoms entering the oxide insulating film 23 from the outside are not moved to the outside of the oxide insulating film 23 and some oxygen remains in the oxide insulating film 23 in some cases. Further, oxygen enters the oxide insulating film 23 and oxygen contained in the oxide insulating film 23 is moved to the outside of the oxide insulating film 23, whereby movement of oxygen in the oxide insulating film 23 occurs in some cases.

An oxide insulating film through which oxygen penetrates is formed as the oxide insulating film 23, so that oxygen released from the oxide insulating film 24 can be moved to the oxide semiconductor film 18 through the oxide insulating film 23.

Further, the oxide insulating film 24 is formed to be in contact with the oxide insulating film 23. The oxide insulating film 24 is formed using an oxide insulating film which contains oxygen at a higher proportion than the stoichiometric composition. Part of oxygen is released by heating from the oxide insulating film which contains oxygen at a higher proportion than the stoichiometric composition. The oxide insulating film which contains oxygen at a higher proportion than the stoichiometric composition is an oxide insulating film in which the amount of released oxygen converted into oxygen atoms is greater than or equal to 1.0×10¹⁸ atoms/cm³, preferably greater than or equal to 3.0×10²⁰ atoms/cm³ in TDS analysis.

As the oxide insulating film 24, a silicon oxide film, a silicon oxynitride film, or the like having a thickness greater than or equal to 30 nm and less than or equal to 500 nm, preferably greater than or equal to 50 nm and less than or equal to 400 nm can be used.

Further, it is preferable that the number of defects in the oxide insulating film 24 be small, and typically the spin density of a signal due to a dangling bond of silicon, which appears when g is 2.001, be lower than or equal to 1.5×10¹⁸ spins/cm³, more preferably lower than or equal to 1×10¹⁸ spins/cm³ by ESR measurement. Since the distance between the multi-layer film 20 and the oxide insulating film 24 is greater than the distance between the multi-layer film 20 and the oxide insulating film 23, the oxide insulating film 24 may have a higher defect density than the oxide insulating film 23.

### <Other Components>

Other components of the transistor 50 are described in detail below.

### <<Substrate>>

There is no particular limitation on the property of a material and the like of the substrate 201 as long as the material has heat resistance enough to withstand at least heat treatment which is performed later. For example, a glass substrate, a ceramic substrate, a quartz substrate, or a sapphire substrate may be used as the substrate 201. Alternatively, a single crystal semiconductor substrate or a polycrystalline semiconductor substrate made of silicon, silicon carbide, or the like, a compound semiconductor substrate made of silicon germanium or the like, an SOI substrate, or the like can be used as the substrate 201. Still alternatively, any of these substrates provided with a semiconductor element may be used as the substrate 201.

Still alternatively, a flexible substrate may be used as the substrate 201, and the transistor 50 may be provided directly on the flexible substrate. Further alternatively, a separation layer may be provided between the substrate 201 and the transistor 50. The separation layer can be used when part or the whole of the semiconductor device formed over the separation layer is formed and separated from the substrate 201 and transferred to another substrate. At this time, the transistor 50 can be transferred to a substrate having low heat resistance or a flexible substrate.

### <<Gate Electrode>>

The gate electrode 15 can be formed using a metal selected from aluminum, chromium, copper, tantalum, titanium, molybdenum, and tungsten; an alloy containing any of these metals as a component; an alloy containing any of these metals in combination; or the like. Further, one or more metals selected from manganese and zirconium may be used. Furthermore, the gate electrode 15 may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film containing aluminum and one or more metals selected from titanium, tantalum, tungsten, molybdenum, chromium, neodymium, and scandium; or a nitride film of the alloy film may be used.

The gate electrode 15 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. It is also possible to have a stacked-layer structure formed using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 15 and the insulating layer 238. These films each have a work function higher than or equal to 5 eV, preferably higher than or equal to 5.5 eV, which is higher than the electron affinity of the oxide semiconductor. Thus, the threshold voltage of the transistor including an oxide semiconductor can be shifted in the positive direction, and what is called a normally-off switching element can be achieved. For example, in the case of using an In—Ga—Zn-based oxynitride semiconductor film, an In—Ga—Zn-based oxynitride semiconductor film having a higher nitrogen concentration than at least the oxide semiconductor film 18, specifically, an In—Ga—Zn-based oxynitride semiconductor film having a nitrogen concentration of 7 at. % or higher is used.

The insulating layer 238 may be formed to have a single-layer structure or a stacked-layer structure using, for example, one or more of silicon oxide, silicon oxynitride, silicon nitride oxide, silicon nitride, aluminum oxide, hafnium oxide, gallium oxide, Ga—Zn-based metal oxide, silicon nitride, and the like.

The insulating layer 238 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, so that gate leakage current of the transistor can be reduced.

The thickness of the gate insulating layer 238 is preferably greater than or equal to 5 nm and less than or equal to 400 nm, more preferably greater than or equal to 10 nm and less than or equal to 300 nm, still more preferably greater than or equal to 50 nm and less than or equal to 250 nm.

### <<Pair of Electrodes>>

The pair of electrodes 21 and 22 is formed to have a single-layer structure or a stacked-layer structure using, as a conductive material, any of metals such as aluminum, titanium, chromium, nickel, copper, yttrium, zirconium, molybdenum, silver, tantalum, and tungsten, or an alloy containing any of these metals as its main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is stacked over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used.

Further, it is possible to prevent outward diffusion of oxygen from the multi-layer film 20 and entry of hydrogen, water, or the like into the multi-layer film 20 from the outside by providing the nitride insulating film 25 having a blocking effect against oxygen, hydrogen, water, and the like over the oxide insulating film 24. As the insulating film that can block oxygen, hydrogen, water, and the like, an aluminum oxide film, an aluminum oxynitride film, a gallium oxide film, a gallium oxynitride film, an yttrium oxide film, an yttrium oxynitride film, a hafnium oxide film, a hafnium oxynitride film, and the like can be given.

### <Method for Manufacturing Backplane Substrate>

Next, a method for manufacturing contact portions together with the transistor 50 in FIGS. 10A to 10C is described with reference to FIGS. 11A to 11D and FIGS. 12A and 12B.

### <<1. Forming Gate Electrode>>

As illustrated in FIG. 11A, the gate electrode 15 is formed over the substrate 201, and the gate insulating layer 238 is formed over the gate electrode 15.

Here, a glass substrate is used as the substrate 201.

A formation method of the gate electrode 15 is described below. First, a conductive film is formed by a sputtering method, a CVD method, an evaporation method, or the like and then a resist mask is formed over the conductive film using a first photomask through a photolithography process. Then, part of the conductive film is etched using the resist mask to form the gate electrode 15. After that, the resist mask is removed.

Note that instead of the above formation method, the gate electrode 15 may be formed by an electrolytic plating method, a printing method, an ink-jet method, or the like.

The gate electrode 15 is formed using a 100-nm-thick tungsten film.

### <<2. Forming Gate Insulating Layer>>

The insulating layer 238 is formed by a sputtering method, a CVD method, an evaporation method, or the like.

In the case where the insulating layer 238 is formed using a silicon oxide film, a silicon oxynitride film, or a silicon nitride oxide film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

In the case of forming a silicon nitride film as the insulating layer 238, it is preferable to use a two-step formation method. First, a first silicon nitride film with a small number of defects is formed by a plasma CVD method in which a mixed gas of silane, nitrogen, and ammonia is used as a source gas. Then, a second silicon nitride film in which the hydrogen concentration is low and hydrogen can be blocked is formed by switching the source gas to a mixed gas of silane and nitrogen. With such a formation method, a silicon nitride film with a small number of defects and a blocking property against hydrogen can be formed as the insulating layer 238.

Moreover, in the case of forming a gallium oxide film as the insulating layer 238, a metal organic chemical vapor deposition (MOCVD) method can be employed.

### <<3. Forming Oxide Semiconductor Film>>

Next, as illustrated in FIG. 11B, the oxide semiconductor film 18 and the oxide film 19 containing In or Ga are formed over the insulating layer 238.

The method for forming the oxide semiconductor film 18 and the oxide film 19 containing In or Ga are described below. An oxide semiconductor film to be the oxide semiconductor film 18 and an oxide film containing In or Ga to be the oxide film 19 containing In or Ga are formed successively over the insulating layer 238. Next, a resist mask is formed over the oxide film containing In or Ga using a second photomask through a photolithography process, and then part of the oxide semiconductor film and part of the oxide film containing In or Ga are etched using the resist mask. Accordingly, as illustrated in FIG. 11B, the multi-layer film 20 including the oxide semiconductor film 18 and the oxide film 19 containing In or Ga which are over the insulating layer 238 and are subjected to element separation to overlap with part of the gate electrode 15 is formed. Then, the resist mask is removed.

The oxide semiconductor film to be the oxide semiconductor film 18 and the oxide film containing In or Ga to be the oxide film 19 containing In or Ga can be formed by a sputtering method, a coating method, a pulsed laser deposition method, a laser ablation method, or the like.

In the case where the oxide semiconductor film and the oxide film containing In or Ga are formed by a sputtering method, a power supply device for generating plasma can be an RF power supply device, an AC power supply device, a DC power supply device, or the like as appropriate.

As a sputtering gas, a rare gas (typically argon), an oxygen gas, or a mixed gas of a rare gas and oxygen is used as appropriate. In the case of using the mixed gas of a rare gas and oxygen, the proportion of oxygen is preferably higher than that of a rare gas.

Note that the target may be selected as appropriate depending on the compositions of the oxide semiconductor film and the oxide film containing In or Ga to be formed.

In the case where the oxide semiconductor film and the oxide film containing In or Ga are formed by, for example, a sputtering method, the oxide semiconductor film and the oxide film containing In or Ga are formed while the substrate is heated at a temperature higher than or equal to 150° C. and lower than or equal to 500° C., preferably higher than or equal to 150° C. and lower than or equal to 450° C., more preferably higher than or equal to 200° C. and lower than or equal to 350° C., whereby the above-described CAAC-OS can be formed.

The oxide semiconductor film and the oxide film containing In or Ga are not formed by simply stacking each film, but are formed to form a continuous junction (here, in particular, a structure in which the energy of the bottom of the conduction band is changed continuously between each film). In other words, the oxide semiconductor film and the oxide film containing In or Ga has a stacked structure such that there exist no impurities which form a defect level such as a trap center or a recombination center, or a barrier inhibiting carrier flow, for the oxide semiconductor film at each interface. If impurities are mixed between the oxide semiconductor film and the oxide film containing In or Ga which are stacked, the continuity of the energy band is lost and carriers disappear by being trapped or recombined at the interface.

To form the continuous junction, each film needs to be stacked successively without exposure to the atmosphere using the multi-chamber film formation apparatus (sputtering apparatus) including the load lock chamber. Each chamber in the sputtering apparatus is preferably subjected to high vacuum evacuation (to a vacuum of about 1×10⁻⁴ Pa to 5×10⁻⁷ Pa) with use of a suction vacuum evacuation pump such as a cryopump in order to remove water or the like which is an impurity for the oxide semiconductor film as much as possible. Alternatively, a turbo-molecular pump is preferably used in combination with a cold trap so that a gas, in particular, a gas including carbon or hydrogen, does not flow backward from an evacuation system to the chamber.

To obtain a highly purified intrinsic oxide semiconductor, a chamber needs to be subjected to high vacuum evacuation, and in addition, a sputtering gas needs to be highly purified. When a highly purified gas having a dew point of −40° C. or lower, preferably −80° C. or lower, more preferably −100° C. or lower is used as an oxygen gas or an argon gas used as a sputtering gas, moisture or the like can be prevented from entering an oxide semiconductor as much as possible.

A 35-nm-thick In—Ga—Zn-based oxide film (In:Ga:Zn=1:1:1) is formed as the oxide semiconductor film by a sputtering method, and then a 20-nm-thick In—Ga—Zn-based oxide film (In:Ga:Zn=1:3:2) is formed as the oxide film containing In or Ga by a sputtering method. Next, a resist mask is formed over the oxide film containing In or Ga, and then part of the oxide semiconductor film and part of the oxide film containing In or Ga are selectively etched, so that the multi-layer film 20 including the oxide semiconductor film 18 and the oxide film 19 containing In or Ga is formed.

After that, heat treatment may be performed.

### <<4. Forming Electrode Layer>>

Next, as illustrated in FIG. 11C, the pair of electrodes 21 and 22 is formed.

A formation method of the pair of electrodes 21 and 22 is described below. First, a conductive film is formed by a sputtering method, a CVD method, an evaporation method, or the like. Then, a resist mask is formed over the conductive film using a third photomask through a photolithography process. Next, the conductive film is etched with use of the resist mask to form the pair of electrodes 21 and 22. Then, the resist mask is removed.

Here, the pair of electrodes 21 and 22 is formed by using a film in which a tungsten film having a thickness of 50 nm, an aluminum film having a thickness of 400 nm, and a titanium film having a thickness of 100 nm are stacked in this order.

### <<5. Forming Insulating Film>>

Next, the oxide insulating film 23 is formed over the multi-layer film 20 and the pair of electrodes 21 and 22. Next, the oxide insulating film 24 is formed over the oxide insulating film 23.

It is preferable to form the insulating film 24 without exposure to the atmosphere, directly after the insulating film 23 is formed. After the oxide insulating film 23 is formed, the oxide insulating film 24 is formed successively by adjusting at least one of the flow rate of the source gas, the pressure, the high-frequency power, and the substrate temperature without exposure to the atmosphere, whereby the concentration of impurities attributed to the atmosphere at the interface between the oxide insulating film 23 and the oxide insulating film 24 can be reduced and further oxygen contained in the oxide insulating film 24 can be moved to the oxide semiconductor film 18; accordingly, the number of oxygen vacancies in the oxide semiconductor film 18 can be reduced.

A silicon oxide film or a silicon oxynitride film is formed as the oxide insulating film 23 under the conditions as follows: the substrate placed in a treatment chamber of a plasma CVD apparatus, which is vacuum-evacuated, is held at a temperature higher than or equal to 180° C. and lower than or equal to 400° C., preferably higher than or equal to 200° C. and lower than or equal to 370° C., the pressure is greater than or equal to 20 Pa and less than or equal to 250 Pa, preferably greater than or equal to 100 Pa and less than or equal to 250 Pa with introduction of a source gas into the treatment chamber, and high-frequency power is supplied to an electrode provided in the treatment chamber.

A deposition gas containing silicon and an oxidizing gas are preferably used as the source gases of the oxide insulating film 23. Typical examples of the deposition gas containing silicon include silane, disilane, trisilane, and silane fluoride. As the oxidizing gas, oxygen, ozone, dinitrogen monoxide, nitrogen dioxide, and the like can be given as examples.

Under the above conditions, an oxide insulating film through which oxygen penetrates can be formed as the oxide insulating film 23. With the oxide film 19 containing In or Ga and the oxide insulating film 23, damage to the oxide semiconductor film 18 can be reduced during a later formation process of the oxide insulating film 24. The pressure in the treatment chamber is set to be higher than or equal to 100 Pa and lower than or equal to 250 Pa, whereby the amount of water contained in the oxide insulating film 23 is reduced; thus, variations of electrical characteristics of the transistor 50 can be reduced and the change in threshold voltage can be suppressed. Further, when the pressure in the treatment chamber is set to be higher than or equal to 100 Pa and lower than or equal to 250 Pa, damage to the multi-layer film 20 including the oxide semiconductor film 18 at the time of forming the oxide insulating film 23 can be reduced, and thus the number of oxygen vacancies contained in the oxide semiconductor film 18 can be reduced. In particular, the formation temperature of the oxide insulating film 23 or the oxide insulating film 24 formed later is increased, typically to higher than 220° C., so that part of oxygen contained in the oxide semiconductor film 18 is released, and oxygen vacancies are formed. To increase reliability of the transistor, the formation conditions for reducing the number of defects in the oxide insulating film 24 formed later are used, whereby the amount of released oxygen is reduced. Accordingly, it becomes difficult to compensate oxygen vacancies in the oxide semiconductor film 18. However, when the pressure in the treatment chamber is set to be higher than or equal to 100 Pa and lower than or equal to 250 Pa to reduce damage to the oxide semiconductor film 18 at the time of forming the oxide insulating film 23, the number of oxygen vacancies in the oxide semiconductor film 18 can be reduced even with the small amount of released oxygen.

Note that when the ratio of the amount of the oxidizing gas to the amount of the deposition gas containing silicon is 100 or higher, the hydrogen content in the oxide insulating film 23 can be reduced. Consequently, the amount of hydrogen entering the oxide semiconductor film 18 can be reduced; thus, the negative shift in the threshold voltage of the transistor can be suppressed.

Further, as the oxide insulating film 23, a silicon oxide film or a silicon oxynitride film can be formed under the following conditions: the substrate placed in a treatment chamber of the plasma CVD apparatus, which is vacuum-evacuated, is held at a temperature higher than or equal to 300° C. and lower than or equal to 400° C., preferably higher than or equal to 320° C. and lower than or equal to 370° C.; the pressure is greater than or equal to 100 Pa and less than or equal to 250 Pa with introduction of the source gas into the treatment chamber; and high-frequency power is supplied to an electrode provided in the treatment chamber.

Under the above film formation conditions, the bonding strength of silicon and oxygen becomes strong in the above substrate temperature range. Consequently, as the oxide insulating film 23, a dense and hard oxide insulating film through which oxygen penetrates, typically, a silicon oxide film or a silicon oxynitride film having an etching rate lower than or equal to 10 nm/min, preferably lower than or equal to 8 nm/min when etching is performed at 25° C. with 0.5 weight % of hydrofluoric acid can be formed.

Here, as the oxide insulating film 23, a 50-nm-thick silicon oxynitride film is formed by a plasma CVD method under the following conditions: silane with a flow rate of 30 sccm and dinitrogen monoxide with a flow rate of 4000 sccm are used as the source gas; the pressure in the treatment chamber is 200 Pa; the substrate temperature is 220° C.; and a high-frequency power of 150 W is supplied to parallel plate electrodes with the use of a 27.12 MHz high-frequency power source. Under the above conditions, a silicon oxynitride film through which oxygen penetrates can be formed.

As the oxide insulating film 24, a silicon oxide film or a silicon oxynitride film is formed under the following conditions: the substrate placed in a treatment chamber of the plasma CVD apparatus that is vacuum-evacuated is held at higher than or equal to 180° C. and lower than or equal to 260° C., preferably higher than or equal to 200° C. and lower than or equal to 240° C.; the pressure is greater than or equal to 100 Pa and less than or equal to 250 Pa, preferably greater than or equal to 100 Pa and less than or equal to 200 Pa with introduction of a source gas into the treatment chamber; and a high-frequency power of 0.17 to 0.5 W/cm², preferably 0.25 to 0.35 W/cm² is supplied to an electrode provided in the treatment chamber.

A deposition gas containing silicon and an oxidizing gas are preferably used as the source gases of the oxide insulating film 24. Typical examples of the deposition gas containing silicon include silane, disilane, trisilane, and silane fluoride. As the oxidizing gas, oxygen, ozone, dinitrogen monoxide, nitrogen dioxide, and the like can be given as examples.

As the film formation conditions of the oxide insulating film 24, the high-frequency power having the above power density is supplied to the reaction chamber having the above pressure, whereby the degradation efficiency of the source gas in plasma is increased, oxygen radicals are increased, and oxidation of the source gas is promoted; therefore, the oxygen content of the oxide insulating film 24 becomes higher than in the stoichiometric composition. However, in the case where the substrate temperature is within the above temperature range, the bond between silicon and oxygen is weak, and accordingly, part of oxygen is released by heating. Thus, it is possible to form an oxide insulating film which contains oxygen at a higher proportion than the stoichiometric composition and from which part of oxygen is released by heating. Further, the oxide insulating film 23 is provided over the multi-layer film 20. Thus, in the formation process of the oxide insulating film 24, the oxide insulating film 23 serves as a protective film of the multi-layer film 20. Further, the oxide film 19 containing In or Ga serves as a protective film of the oxide semiconductor film 18. Consequently, the oxide insulating film 24 can be formed using the high-frequency power having a high power density while damage to the oxide semiconductor film 18 is reduced.

In the formation conditions of the oxide insulating film 24, the increase in flow rate of the deposition gas including silicon with respect to the flow rate of the oxidation gas makes it possible to reduce the number of defects in the oxide insulating film 24. Typically, it is possible to form an oxide insulating film in which the number of defects is small (i.e. the spin density of a signal which appears at g=2.001 due to a dangling bond of silicon is lower than 6×10¹⁷ spins/cm³, preferably lower than or equal to 3×10¹⁷ spins/cm³, more preferably lower than or equal to 1.5×10¹⁷ spins/cm³ by ESR measurement). As a result, reliability of the transistor can be improved.

Here, as the oxide insulating film 24, a 400-nm-thick silicon oxynitride film is formed by a plasma CVD method under the following conditions: silane with a flow rate of 200 sccm and dinitrogen monoxide with a flow rate of 4000 sccm are used as the source gas, the pressure in the reaction chamber is 200 Pa, the substrate temperature is 220° C., and the high-frequency power of 1500 W is supplied to parallel plate electrodes with the use of a 27.12 MHz high-frequency power source. Note that the plasma CVD apparatus is a parallel plate plasma CVD apparatus in which the electrode area is 6000 cm², and the power per unit area (power density) into which the supplied power is converted is 0.26 W/cm².

Next, heat treatment is performed. The temperature of the heat treatment is typically higher than or equal to 150° C. and lower than the strain point of the substrate, preferably higher than or equal to 200° C. and lower than or equal to 450° C., more preferably higher than or equal to 300° C. and lower than or equal to 450° C.

An electric furnace, an RTA apparatus, or the like can be used for the heat treatment. With the use of an RTA apparatus, the heat treatment can be performed at a temperature of higher than or equal to the strain point of the substrate if the heating time is short. Therefore, the heat treatment time can be shortened.

The heat treatment may be performed under an atmosphere of nitrogen, oxygen, ultra-dry air (air in which a water content is 20 ppm or less, preferably 1 ppm or less, more preferably 10 ppb or less), or a rare gas (argon, helium, or the like). The atmosphere of nitrogen, oxygen, ultra-dry air, or a rare gas preferably does not contain hydrogen, water, and the like.

By the heat treatment, part of oxygen contained in the oxide insulating film 24 can be moved to the oxide semiconductor film 18 to compensate the oxygen vacancies in the oxide semiconductor film 18. Consequently, the number of oxygen vacancies in the oxide semiconductor film 18 can be reduced. The oxide insulating film 24 is formed over the oxide insulating film 23 while being heated, whereby oxygen can be moved to the oxide semiconductor film 18 to compensate the oxygen vacancies in the oxide semiconductor film 18; thus, the heat treatment is not necessarily performed.

Here, the heat treatment is performed at 350° C. for 1 hour in an atmosphere of nitrogen and oxygen.

Further, when the pair of electrodes 21 and 22 is formed, the multi-layer film 20 is damaged by the etching of the conductive film, so that oxygen vacancies are generated on the back channel side of the multi-layer film 20. The use of an oxide insulating film which contains oxygen at a higher proportion than the stoichiometric composition as the oxide insulating film 24 can fill the oxygen vacancies generated on the back channel side by the heat treatment. In such a manner, defects in the multi-layer film 20 can be reduced; thus, the reliability of the transistor 50 can be improved.

Through the above-described process, the transistor 50 can be manufactured.

The oxide insulating film which contains oxygen at a higher proportion than the stoichiometric composition is formed to overlap with the oxide semiconductor film serving as a channel region, whereby oxygen in the oxide insulating film can be moved to the oxide semiconductor film. Consequently, the number of oxygen vacancies in the oxide semiconductor film can be reduced.

In particular, when an oxide insulating film through which oxygen penetrates is formed between the oxide semiconductor film serving as a channel region and the oxide insulating film which contains oxygen at a higher proportion than the stoichiometric composition, damage to the oxide semiconductor film at the time of forming the oxide insulating film which contains oxygen at a higher proportion than the stoichiometric composition can be suppressed. Consequently, the number of oxygen vacancies in the oxide semiconductor film can be reduced.

When the oxide film containing In or Ga is formed over the oxide semiconductor film, damage to the oxide semiconductor film at the time of forming the oxide insulating film which contains oxygen at a higher proportion than the stoichiometric composition can be further suppressed. In addition, by forming the oxide film containing In or Ga, entry of the constituent elements of an insulating film formed over the oxide semiconductor film, e.g., the oxide insulating film, into the oxide semiconductor film can be suppressed.

Thus, a semiconductor device including an oxide semiconductor film and having a reduced number of defects can be obtained. Further, a semiconductor device including an oxide semiconductor film and having improved electrical characteristics can be obtained.

### <<6. Forming Openings>>

Next, as illustrated in FIG. 12A, openings are formed in the insulating layer 239 and the insulating layer 238.

A resist mask is formed using a fourth photomask through a photolithography process, and then the nitride insulating film 25, the oxide insulating film 24, and the oxide insulating film 23 are etched using the resist mask, so that an opening reaching the electrode 21 and an opening reaching a wiring 32 which is formed in the same step as the pair of electrodes 21 and 22 are formed as illustrated in FIG. 12A. Further, the insulating layer 238 is etched, whereby an opening reaching a wiring 31 which is formed in the same step as the gate electrode 15 is formed.

### <<7. Forming First Electrode>>

Next, as illustrated in FIG. 12B, the first electrode 251 is formed over the insulating layer 239.

A formation method of the first electrode 251 is described below. First, a light-transmitting conductive film is formed by a sputtering method, a CVD method, an evaporation method, or the like. Then, a resist mask is formed over the conductive film using a fifth photomask through a photolithography process. Next, the light-transmitting conductive film is etched with use of the resist mask to form the first electrode 251 and a wiring 33. Then, the resist mask is removed.

In such a manner, contact portions can be formed together with the transistor 50.

Note that the backplane formed in this embodiment can be used for a display device of one embodiment of the present invention. For example, the backplane can be used for a display panel described in Embodiment 4.

This embodiment can be combined with any of the other embodiments disclosed in this specification as appropriate.

This application is based on Japanese Patent Application serial No. 2012-239682 filed with Japan Patent Office on Oct. 30, 2012, the entire contents of which are hereby incorporated by reference.

What is claimed is:

1. A method for driving a display device comprising:
determining whether still image data is two-valued still image data or multivalued still image data;
performing display by rewriting at first frequency in a case where still image data is multivalued still image data; and
performing display by rewriting at second frequency in a case where the still image data is two-valued still image data,
wherein the first frequency is higher than the second frequency.

2. The method for driving a display device according to claim 1, wherein a step of determining is made based on information that the still image data includes the multivalued data or not.

3. The method for driving a display device according to claim 1, wherein a step of determining is made based on metafile having information that the still image data includes the multivalued data or not.

4. The method for driving a display device according to claim 1, wherein the display is terminated after the predetermined period passes.

5. The method for driving a display device according to claim 1, wherein the display is terminated when a termination signal is input by the user through an input device.

6. The method for driving a display device according to claim 1, wherein the display is terminated after a step of rewriting the two-valued still image data is repeated predetermined times.

7. A method for driving a display device comprising:
determining whether image data is moving image data or still image data;
performing display by rewriting at first frequency in a case where the image data is moving image data;
determining whether the still image data is two-valued still image data or multivalued still image data in a case where the image data is still image data;
performing display by rewriting at second frequency in a case where the still image data is multivalued still image data; and
performing display by rewriting at third frequency in a case where the still image data is two-valued still image data,
wherein the first frequency is higher than the second frequency, and
wherein the second frequency is higher than the third frequency.

8. The method for driving a display device according to claim 7, wherein a step of determining whether the still image data is two-valued still image data or multivalued still image data is made based on information that the still image data includes the multivalued data or not.

9. The method for driving a display device according to claim 7, wherein a step of determining whether the still image data is two-valued still image data or multivalued still image data is made based on metafile having information that the still image data includes the multivalued data or not.

10. The method for driving a display device according to claim 7, wherein the display is terminated after the predetermined period passes.

11. The method for driving a display device according to claim 7, wherein the display is terminated when a termination signal is input by the user through an input device.

12. The method for driving a display device according to claim 7, wherein the display is terminated after a step of rewriting the two-valued still image data is repeated predetermined times.

13. A method for driving a display device comprising:
determining whether first still image data is two-valued still image data or multivalued still image data;
performing display by rewriting at first frequency in a case where the first still image data is multivalued still image data;
performing display by rewriting at second frequency in a case where the first still image data is two-valued still image data; and
switching from the first still image data to second still image data, and writing the data from first interpolation image data to N-th interpolation image data (N is a natural number) at third frequency in sequence during the period after the first still image data is displayed and before the second still image data is displayed,
wherein the first frequency is higher than the second frequency, and
wherein the third frequency is higher than the first frequency.

14. The method for driving a display device according to claim 13, wherein a step of determining is made based on information that the still image data includes the multivalued data or not.

15. The method for driving a display device according to claim 13, wherein a step of determining is made based on metafile having information that the still image data includes the multivalued data or not.

16. The method for driving a display device according to claim 13, wherein the display is terminated after the predetermined period passes.

17. The method for driving a display device according to claim 13, wherein the display is terminated when a termination signal is input by the user through an input device.

18. The method for driving a display device according to claim 13, wherein the display is terminated after a step of rewriting the two-valued still image data is repeated predetermined times.

19. The method for driving a display device according to claim 13, wherein the first interpolation image data to the N-th interpolation image data are generated by obtaining weighted average of the first still image data and the second still image data using successively varying coefficients.
